(19) United States
(12) Patent Application Publication
(10) Pub. No.: US 2019/0273718 A1
(43) Pub. Date: Sep. 5, 2019

(54) INTERCEPTING NETWORK TRAFFIC ROUTED BY VIRTUAL SWITCHES FOR SELECTIVE SECURITY PROCESSING

(71) Applicant: ShieldX Networks, Inc., San Jose, CA (US)

(72) Inventors: Ratinder Paul Singh Ahuja, Saratoga, CA (US); Manuel Nedbal, Santa Clara, CA (US); Meni Hillel, San Jose, CA (US)

(21) Appl. No.: 15/909,925

(22) Filed: Mar. 1, 2018

(51) Int. Cl. H04L 29/06; H04L 12/46; H04L 29/12; G06F 9/455

(52) U.S. Cl. CPC H04L 63/0236; H04L 12/4641; G06F 2009/45595; G06F 9/45558; G06F 2009/45587; H04L 61/2517

(57) ABSTRACT

Systems, methods, and apparatuses enable a microservice to intercept and filter network traffic generated by virtual machines (VMs) and routed by a virtual switch (vSwitch). The system assigns a unique port group and identifier (e.g., a VLAN) to each VM, and maintains a mapping between the unique identifier and a VLAN used to communicate network traffic from the vSwitch to a physical switch. When network traffic is sent from a VM, the network traffic is intercepted by a trunk and sent to a microservice. The microservice performs a mapping procedure to identify the VLAN for transmitting the network traffic to the physical switch. The microservice determines whether the network traffic requires further inspection or analysis, or whether the network traffic can be transmitted to the physical switch using the VLAN identified during the mapping procedure.

### TECHNICAL FIELD

Embodiments relate generally to computer network security. More specifically, embodiments relate to techniques for intercepting network traffic routed by virtual switches and filtering the intercepted traffic for the selective application of security services.

### BACKGROUND

Businesses and organizations rely on computer systems and networks for an increasingly wide variety of business operations. As the reliance on these systems and networks has grown, so too has the importance of securing those computer systems and networks against internal and external security threats. However, the breadth and complexity of security threats targeting such computer systems and networks is far and wide and ever growing. To monitor and address these security threats, organizations increasingly rely on sophisticated computer network security applications and hardware such as firewalls, anti-virus tools, data loss prevention (DLP) software, etc.

One aspect of a network security application often involves monitoring and performing security operations on network traffic generated by monitored components of a computing environment. For example, a security application might use deep packet inspection (DPI) operations, DLP operations, and other services to analyze network traffic for the presence of potential security threats. In computing environments which include virtualized computing resources, for example, the network traffic to be monitored can include traffic generated by virtual machines (VMs) and applications running thereon.

### BRIEF DESCRIPTION OF THE DRAWINGS

The various advantages of the embodiments disclosed herein will become apparent to one skilled in the art by reading the following specification and appended claims, and by referencing the drawings, in which:

FIG. 1 is a block diagram illustrating computer hardware for loading network security system microservices from a memory and executing them by a processor in accordance with the disclosed embodiments;

FIG. 2 illustrates a scalable security architecture implementing a three-time scale out using security microservices in accordance with the disclosed embodiments;

FIG. 3 illustrates an arbitrary scaling out of a microservice in accordance with the disclosed embodiments;

FIG. 4 is a block diagram illustrating a security service configured to monitor traffic sent among an application and one or more servers through a routing network in accordance with the disclosed embodiments;

FIG. 5 is a block flow diagram illustrating application data traversing to a server after passing through a hierarchy of a security microservices in accordance with the disclosed embodiments;

FIG. 6 is a flow of application data through a stateless processing, fault-tolerant microservice environment in accordance with the disclosed embodiments;

FIG. 7 is a block diagram illustrating an example computing device running at least one virtual machine (VM) coupled to a routed network via a virtual switch (vSwitch) in accordance with the disclosed embodiments;

FIG. 8 is a block diagram illustrating example port group settings in accordance with the disclosed embodiments;

FIG. 9 is a block diagram illustrating an example computing device including an interface microservice configured to intercept network traffic routed through a vSwitch in accordance with the disclosed embodiments;

FIGS. 10A, 10E3 is a flow diagram illustrating an example method for configuring an interface microservice to intercept network traffic routed by a vSwitch in accordance with the disclosed embodiments;

FIG. 11 is a block diagram illustrating an example computing device including an interface microservice configured to intercept and filter network traffic routed by a vSwitch in accordance with the disclosed embodiments;

FIG. 12 is a block diagram illustrating example filter definitions in accordance with the disclosed embodiments;

FIG. 13 is a flow diagram illustrating an example method used to filter network traffic routed by a vSwitch and intercepted by an interface microservice in accordance with the disclosed embodiments;

FIG. 14 is a block diagram illustrating an example system using port groups to facilitate transmission of data through a switched network environment accordance with the disclosed embodiments

FIG. 15 is a block diagram illustrating an example system including microservices to intercept and perform security actions on network traffic in accordance with the disclosed embodiments

FIG. 16 is a block diagram illustrating an example system including microservices to intercept and perform security actions on network traffic sent between VMs in accordance with the disclosed embodiments.

FIGS. 17A, 17B is a flow diagram illustrating an example method for configuring an interface microservice to intercept network traffic routed by a vSwitch in accordance with the disclosed embodiments; and

FIG. 18 is a block diagram that illustrates a computer system utilized in implementing the above-described techniques in accordance with some of the disclosed embodiments.

### DETAILED DESCRIPTION

In the following description, for the purposes of explanation, numerous specific details are set forth in order to provide a thorough understanding of embodiments of the present invention. It will be apparent, however, that embodiments of the present invention may be practiced without these specific details. In other instances, well-known structures and devices are shown in block diagram form to avoid unnecessarily obscuring embodiments of the present invention.

References in the specification to “one embodiment,” “an embodiment,” “an example embodiment,” etc., indicate that the embodiment described may include a particular feature, structure, or characteristic, but every embodiment need not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments are described herein according to the following outline:

1.0. General Overview

2.0. Operating Environment
2.1. System Overview
2.2. Microservice for Intercepting Network Traffic

3.0. Functional Overview
3.1. Configuring a vSwitch for Traffic Interception
3.2. Micro-Segmentation

5.0. Example Embodiments

6.0. Implementation Mechanism—Hardware Overview

7.0. Extensions and Alternatives

### 1.0. GENERAL OVERVIEW

Modern data centers and other computing environments can include anywhere from a few computer systems to thousands of systems configured to process data, service requests from remote clients and other applications, and perform numerous other computational tasks. The large number of interworking systems, applications, etc., make such computing environments susceptible to a wide variety of network security threats and other issues. A number of network security tools are available to protect such systems and the computer networks interconnecting these systems, and many of these tools comprise a monolithic set of network security functions. For example, a typical network security tool might comprise a hardware unit including firewall services, routing services, virtual private network (VPN) services, and so forth.

The type of network security tool described above is useful for providing a variety of network security functions as a single unit. However, efficiently scaling these types of network security tools is often challenging. For example, if a particular computer environment might benefit from increased firewall resources, a system administrator may install one or more additional hardware units each including firewall services in addition to a suite of other network security functions. While the addition of these new hardware units may meet the increased firewall resource needs, some of the hardware units may include unnecessary and/or underutilized resources devoted to virtual private network (VPN) services, data loss prevention (DLP) services, or other security services.

One way in which many modern computing environments scale resources more efficiently is using virtualized computing resources. A virtualized computing resource generally refers to an abstracted physical computing resource presented to an operating system and its applications by means of a hypervisor, such that the virtual computing resources (compute, memory, network connectivity, storage, etc.) are configurable and may be different from those of the physical computing resource. According to one embodiment, these types of virtualized infrastructures are used to efficiently scale network security applications based on the use of “microservices,” where a microservice is a particular type of virtualized computing resource packaged as a software container. For example, a network security platform may comprise separate microservices providing firewall resources, DLP services, VPN services, etc. In general, the use of such microservices can provide greater flexibility because the microservices can be more easily deployed and scaled in response to variable demands for various types of network security services.

The type of efficient network security application scaling described above can be achieved with the use of a security application that is configured to scale network security services using microservices. Although many of the techniques described herein are explained with reference to a microservice-based network security application, the techniques are also applicable to other types of network security systems.

Computing environments including VMs may further include one or more virtual switches (also referred to herein as a “vSwitch”), where a vSwitch manages network traffic for some number of VMs connected to virtualized ports of the vSwitch and forming one or more virtual local area networks (VLANs). The configuration of vSwitch can also include port groups, where a port group is a logical grouping of vSwitch ports (and by extension the VMs connected to those ports). Furthermore, port groups of a vSwitch can be assigned a trunk, where a trunk merges a group of virtual network links into a single logical link and can enable VLANs to span across different vSwitches.

While the ability to assign vSwitch ports to port groups and trunks can provide efficiencies in managing network traffic at the vSwitch, these configurations also present challenges for examining traffic routed by a vSwitch for security purposes. For example, traffic among VMs within the same port group will not be observed by a security service as the security service only observes traffic traversing port group boundaries. This prevents the security service from observing VM to VM traffic that may be indicative of a lateral infiltration (a security compromise spreading from peer to peer). This also prevents the security service from observing VM to VM traffic that could be used to establish baseline behaviors and traffic patterns to establish risk levels.

### 2.0. OPERATING ENVIRONMENT

### 2.1. System Overview

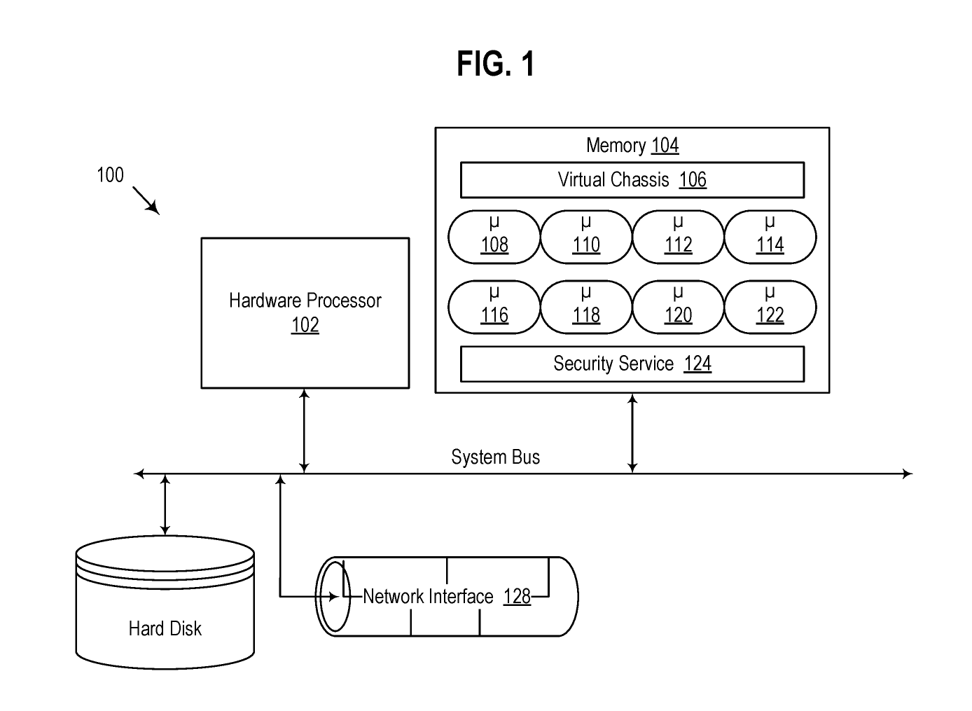

FIG. 1 is a block diagram illustrating an embodiment of a scalable microservice architecture using microservices. Network security system microservices 108-122 are stored in memory 104 (e.g., volatile memory such as Random Access Memory (RAM) and/or non-volatile memory such as disk) and executed by one or more hardware processors or processor cores 102. Network security system microservices 108-122, consisting of computer-executable instructions to perform one or more specific security services, are deployed based on configuration across available physical servers. Typically, each microservice receives a configuration and tasks via a backplane of a virtual chassis 106, and returns status, statistics, and other information to the backplane.

The data processed by the network security system 100 is transferred from a microservice to another (higher hierarchy) microservice using a data plane. In some embodiments, during such a transfer, a lower microservice decides (based on configuration, current statistics, and other information) as to which next microservice to utilize. Such a decision may constitute a load-balancing decision to assure that the higher-hierarchy microservices are efficiently utilized. In other embodiments, the decision of which microservice to utilize is made by a more central entity.

As illustrated, a network security system 100 utilizes a hardware processor 102 (such as a central processing unit (CPU) or one or more cores thereof, a graphics processing unit (GPU) or one or more cores thereof, or an accelerated processing unit (APU) or one or more cores thereof) to execute microservices stored in memory 104. A network interface 128 (e.g., fabric or interconnect that is wired or wireless) provides a means for communicating with a data center. Network security system 100 may inspect traffic, detect threats, and otherwise protects a data center using the microservices 108-122.

Embodiments of a network security system 100 providing the above capabilities are now discussed in more detail. Network security system 100 adds security to, or enhances the security of, a datacenter or other computing environment. In an embodiment, network security system 100 is delivered (e.g., downloaded) in the form of a seed software application. The seed software application instantiates microservices of the network security system on a host in the datacenter. As used herein, a microservice container refers to where the microservice runs, for example, on a virtual machine. Once deployed, network security system 100 utilizes a hardware processor 102, memory 104, and network interface 128. In many scenarios, security can be added/configured using existing hardware and/or without purchasing additional rack devices for particular functionality. The seed software application may be installed on any one of a wide variety of hosts—be they slow or fast, low-cost or high-cost, commodity or customized, geographically dispersed, part of a redundancy scheme, or part of a system with regular back-ups.

In some embodiments, a network security system 100 utilizes a network interface 128 to explore the datacenter and to discover existing network segments, determine security settings to apply to various network segments, detect available hosts and hardware resources, and determine additional configuration information as needed. In an embodiment, the datacenter itself includes several machines with hypervisors, or physical hardware, and the network security system 100 offers microservices to communicate with and protect one or more of those internal virtual machines or physical hardware. Based on performing datacenter discovery, a network security system 100, in some embodiments, may then offer or suggest available security tools for selection either through a graphical interface or via connections with existing enterprise management software. In one embodiment, once configured, a network security system 100 is deployed “in-line,” receiving packets headed for the datacenter, thereby allowing network security system to intercept and block suspicious traffic before it reaches the datacenter. With an understanding of the datacenter, a network security system 100 deploys microservices to inspect traffic throughout the datacenter, and not only at ingress. In some embodiments, a network security system 100 is deployed in a “copy only” configuration, in which the system monitors traffic, detects threats, and generates alerts, but does not intercept traffic before it arrives at the datacenter.

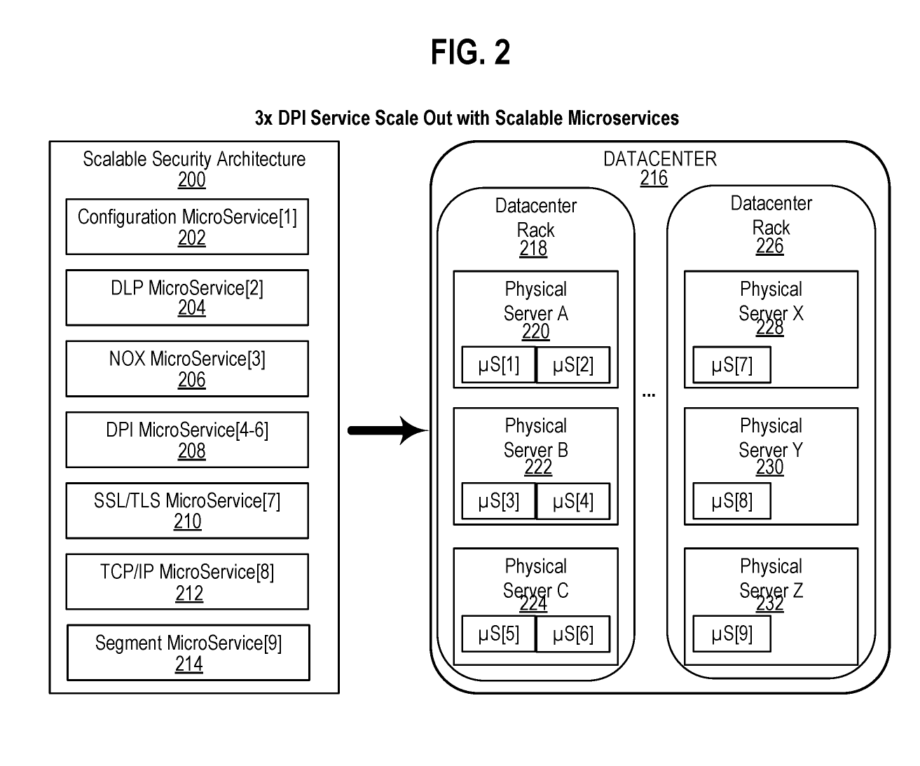

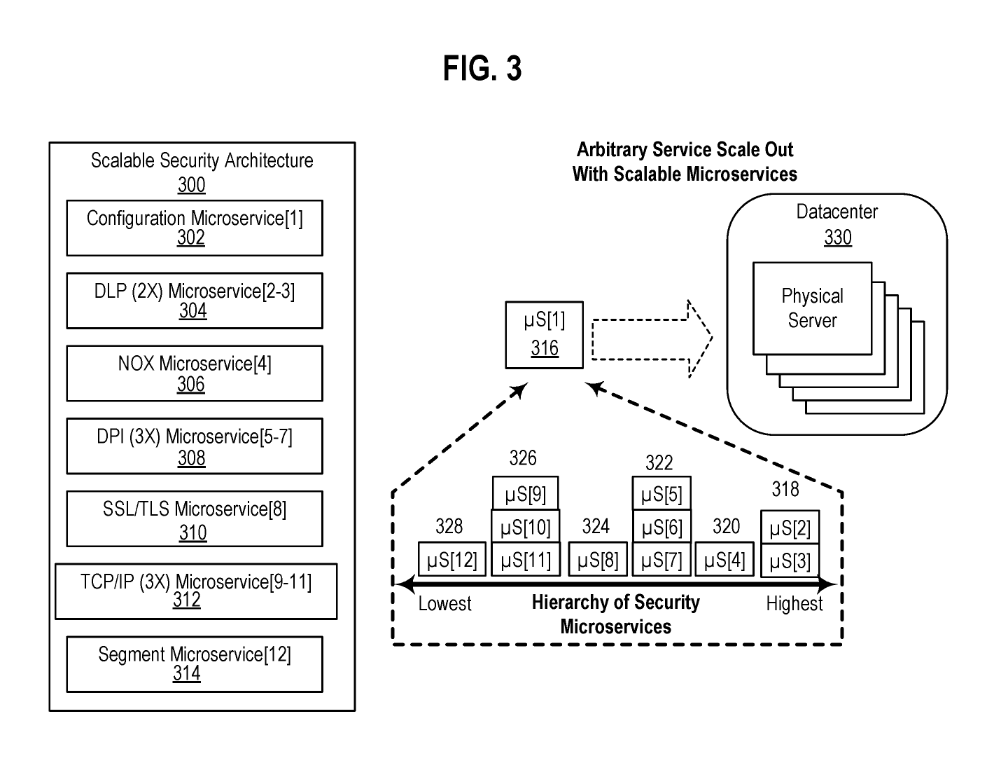

As shown, memory 104 has stored therein microservices 108, 110, 112, 114, 116, 118, 120, and 122 (108-122), as well as a virtual chassis 106, which is also a microservice. In an embodiment, the microservices are small in size, consisting of a relatively small number of instructions. In an embodiment, the microservices 108-122 are independent of each other. As illustrated, microservices 108-122 are microservices that are loaded from memory and executed by the hardware processor 102. Those microservices 108-122 include data path security microservices, for example TCP/IP, SSL, DPI, or DLP microservices, as described further below with respect to FIGS. 2 and 3. The microservices 108-122 may also include management microservices, for example, a chassis controller to manage the microservices, a configuration microservice, an infrastructure discovery microservice, a database microservice to store data, a policy update microservice to receive policy updates from an external security cloud, and a compiler to receive policy data from various sources and to produce binary policy outputs to be used by the microservices, to name a few examples that are described hereinafter with respect to FIGS. 2 and 3.

Memory 104 also stores security service 124. Security service 124 is configured to utilize a plurality of microservices to perform security operations on intercepted network traffic, including evaluating network traffic for potential security threats and executing security actions on network traffic determined to present a security threat. In one embodiment, security service 124 utilizes one or more microservices to intercept network traffic communicated between VMs assigned to a single port group to evaluate the network traffic for malicious data. In another embodiment, security service 124 utilizes one or more microservices to intercept network traffic communicated between VMs, where each VM is assigned a unique port group and VLAN. In various embodiments, an interface (e.g., a segment interface) utilizes a stored mapping that maps the VLANs assigned to each VM to the VLAN used by a virtual distributed switch for communications with a physical switch 1410. In one embodiment, the embodiments disclosed herein are performed by security service 124. In other embodiments, the embodiments disclosed herein are performed by microservices (e.g., microservices 108-122) based on instructions from security service 124.

It will be understood by those of ordinary skill in the art that a datacenter typically employs many instances of the hardware represented within network security system 100 such as hardware processor 102 and memory 104. Individual servers may have multiple processors or multiple processing boards each with multiple processors. Processors may have a plurality of processing cores and access a plurality of network interfaces. Security service 124 comprises program code executing within a processor and may have interfaces (such as configuration or administration user interfaces) that are made available over a network to users. In a virtualized environment, the user may not be aware of the specific processor on which security service 124 is executing and, in some embodiments, that processor may change based on loading of the virtual environment. Such changes may occur based on administrator requests or automatically based on the virtual environment's control software.

In an embodiment, a network security system 100 receives traffic via network interface 128 to/from a datacenter. In one embodiment, a network security system 100 is placed in-line to inspect traffic, and potentially intercept a threat before it arrives at, or leaves, the datacenter. In other embodiments, a network security system 100 monitors the traffic heading into, or out of, the datacenter, in which case the network security system 100 detects threats and generates alerts, but does not block the data. A hardware processor 102 may execute various data security microservices on the data. For example, as described hereinafter with respect to FIGS. 2 and 3, typically traffic first passes into and through a segment microservice, then a TCP/IP inspection microservice, then a SSL microservice, then a DPI microservice, then a NOX microservice, and then a DLP microservice. However, one or more of these services may not be enabled. In some embodiments, a segment microservice resides within a network segment and serves as the entry point for data packets and forwards the packets to appropriate microservices for further analysis. Data path microservices as used herein refer to various microservices that inspect and analyze network traffic, such as TCP, TLS, DPI, NOX, and DLP microservices. A TCP microservice, for example, refers to a packet handling microservice able to process any layer 4-6 network packet and includes part of firewalling. A TLS microservice, for example, refers to a Transport Layer Security microservice, which decrypts/re-encrypts connections. A DPI microservice, for example, refers to a Deep Packet Inspection microservice and handles layer 7 inspection. A NOX microservice, for example, refers to a Network Object Extractor microservice, and works in conjunction with DPI to assemble objects from individual packets and to deliver the objects to other services. A DLP microservice, for example, refers to a Data Loss Prevention microservice, which detects and attempts to prevent data loss. Control path microservices, on the other hand, are various microservices, such as a factory, a compiler, a configuration, an infrastructure discovery, a database, a messenger, a scaler, and a chassis controller, that are instantiated in, and make up, a management plane. Threats detected by the aforementioned microservices, in one embodiment, are reported to a chassis controller microservice, which takes remedial action.

In an embodiment, microservices 108-122 are implemented using computer-executable instructions loaded from the Internet via network interface 128. For instance, in an embodiment, the microservices are implemented with computer-executable instructions downloaded from a web site or online store site. In some embodiments, microservices 108-122 are loaded into memory 104. In various embodiments, the microservices are implemented using computer-executable instructions loaded on and received from a non-transitory computer readable medium, such as digital media, including another disc drive, a CD, a CDROM, a DVD, a USB flash drives, a Flash memory, a Secure Digital (SD) memory card, a memory card, without limitation. Microservices received from a digital medium may be stored into memory 104. The embodiments are not limited in this context. In further embodiments, a digital medium is a data source that constitutes a combination of hardware elements such as a processor and memory.

In most embodiments, a network security system 100 runs on a datacenter computer. In other embodiments, however, a network security system 100 is installed and runs on any one of a wide variety of computing platforms, ranging from low-cost to high-cost, and from low-power to high power. In some embodiments, a network security system 100 runs on a server. In some embodiments, a network security system 100 is installed on and runs on a low-cost, commodity server computer, or on a low-cost rack-mounted server. As illustrated, hardware processor 102 is a single core processor. In alternate embodiments, hardware processor 102 is a multi-core processor. In alternate embodiments, hardware processor 102 is a massively parallel processor. In some embodiments, a virtual chassis 106 and microservices 108-122 may be hosted on any of a wide variety of hardware platforms used in the datacenter to be protected.

In some embodiments, a network security system 100 scales out using available resources to accommodate higher traffic or load. In one embodiment, hardware processor 102 (CPU) and memory 104 are scaled out or in dynamically as needed: additional CPUs and memory are added if scaling out, and some CPUs and/or memory are powered down if scaling in. This scaling out is performed to allocate the additional CPUs and memory to those portions of the security hierarchy for which there is demand, while not allocating additional CPUs and memory to those portions of the security hierarchy that can accommodate the higher traffic utilizing their existing allocation.

One property of a microservice is the separation and protection of memory from other microservices. In this manner, an individual microservice may be moved to another physical server or terminate abnormally without impacting other microservices. Microservices may be distinguished from threads in that threads generally operate within a shared memory space and exist within the confines of an operating system on which the microservices were spawned.

FIG. 2 illustrates an example scalable security architecture implementing a three-time scale out using security microservices in accordance with the disclosed embodiments. In the example of FIG. 2, only a single microservice (e.g., a DPI microservice) has a demand for additional resources. As shown, by utilizing a scalable microservice architecture 200, including DLP microservice 204, NOX microservice 206, DPI microservice 208, SSL/TLS microservice 210, TCP/IP microservice 212, and segment microservice 214, each layer of the security service hierarchy can be scaled and configured independently to load balance the supply of processed data to the next hierarchy level. As shown, datacenter 216 includes datacenter rack 218, which includes physical server A 220, physical server B 222, and physical server C 224. As shown, a datacenter rack 226 includes physical server X 228, physical server Y 230, and physical server Z 232. DPI microservices 208 have been scaled out 3X, and in this instance assigned to be performed as microservices 4-to-6 on physical server B 222 and physical server C 224. The remaining microservices of scalable security architecture are shown as being implemented by physical servers A, X, Y, and Z (220, 228, 230, and 232, respectively). A configuration microservice 202 creates a configuration backplane and a data plane deployed as a software component on each physical server that is to receive security services. This process includes configuring routing rules, reserving network address space (such as a subnet), and configuring virtual environments to utilize portions of the reserved address space as gateways for network communication in and out of the servers to be secured. Both the backplane and data plane may thus be considered virtual networks managed by the security system. Security microservices may then utilize these networks to transmit packets, content, state, and other information among the microservices. The properties of the backplane and data plane are configured to reject packet traffic from outside the security system and to route information between microservices regardless of the physical server and virtual environment configuration.

FIG. 3 illustrates an arbitrary scaling out of a microservice according to an embodiment. As shown, scalable security architecture 300 includes configuration microservice 302, DLP (2X) microservice 304 (a 2-times scale-out), NOX microservice 306, DPI (3X) microservice 308 (a 3-times scale-out), SSL/TLS microservice 310, TCP/IP (3X) microservice 312 (a 3-times scale-out), and segment microservice 314. As shown, configuration microservice 316 provisions (318, 320, 322, 324, 326, and 328) the 11 microservices from a lowest hierarchy to a highest hierarchy, and configures them to communicate with each other via a backplane. The microservices, for example, may be implemented by physical servers in datacenter 330.

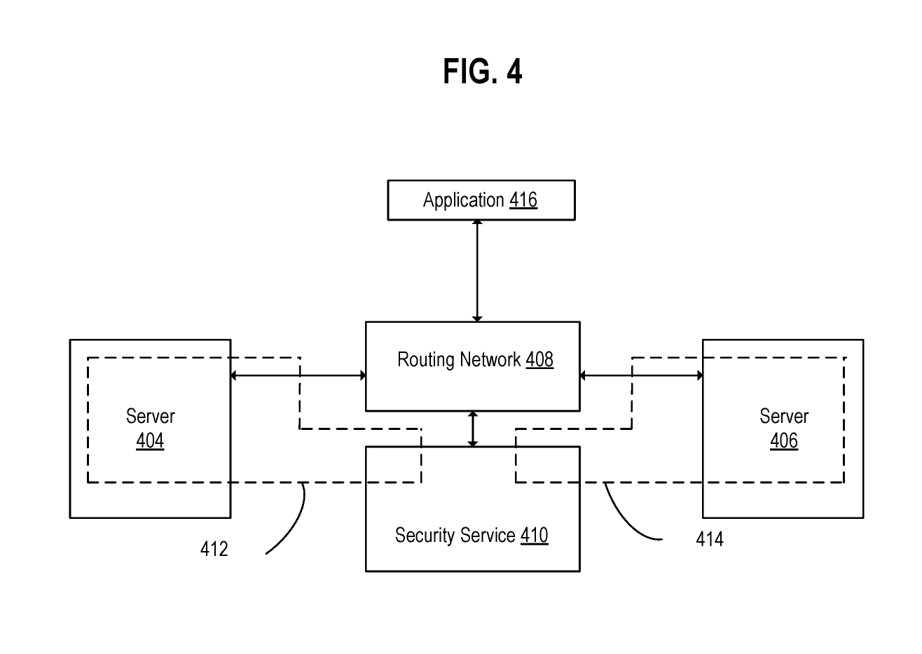

FIG. 4 is a block diagram illustrating a networked computing environment in which an embodiment may be implemented. FIG. 4 represents an example embodiment that is provided for purposes of illustrating a clear example; other embodiments may use different arrangements.

The networked computer system depicted in FIG. 4 comprises one or more computing devices. These one or more computing devices comprise any combination of hardware and software configured to implement the various logical components described herein. For example, the one or more computing devices may include one or more memories storing instructions for implementing the various components described herein, one or more hardware processors configured to execute the instructions stored in the one or more memories, and various data repositories in the one or more memories for storing data structures utilized and manipulated by the various components.

In one embodiment, one or more security services 410 may be configured to monitor network traffic and other data sent between an application 416 and one or more servers 404, 406 through a routing network 408. In one embodiment, security service 410 is an example of security service 124, depicted in FIG. 1. The security service 410 comprises one or more “microservices” used to monitor and perform various actions relative to data items (e.g. network traffic, files, email messages, etc.) sent to and received from one or more applications 416 and servers 404, 406. The microservices comprising security service 410 may not be confined to one physical server such as a server 404, 406. For example, one or more microservices of the security service 410 may be executed on server 404, and other microservices of the security service 410 may be executed on server 406. In some embodiments, the security service 410 is executed on a different server from one or more servers for which the security service is responsible for monitoring and protecting.

In an embodiment, a routing network 408 provides connectivity among servers 404, 406, security service 410, and application 416. In some embodiments, routing network 408 is partially configured responsive to hypervisor configuration of servers 404 and 406. In some embodiments, a routing network 408 is partially or entirely configured responsive to hypervisor configuration of servers 404 and/or 406.

In one embodiment, by virtue of routing information included in channel data encapsulation packets, data traveling between an application 416 and server 404 and/or server 406 is routed to the correct server, and is kept separate from data traveling between the application 416 and the other server. Accordingly, what is essentially a private network 412 may be created between the server running security service 410 and server 404. Similarly, what is essentially a private network 414 may be created between the server running security service 410 and server 406.

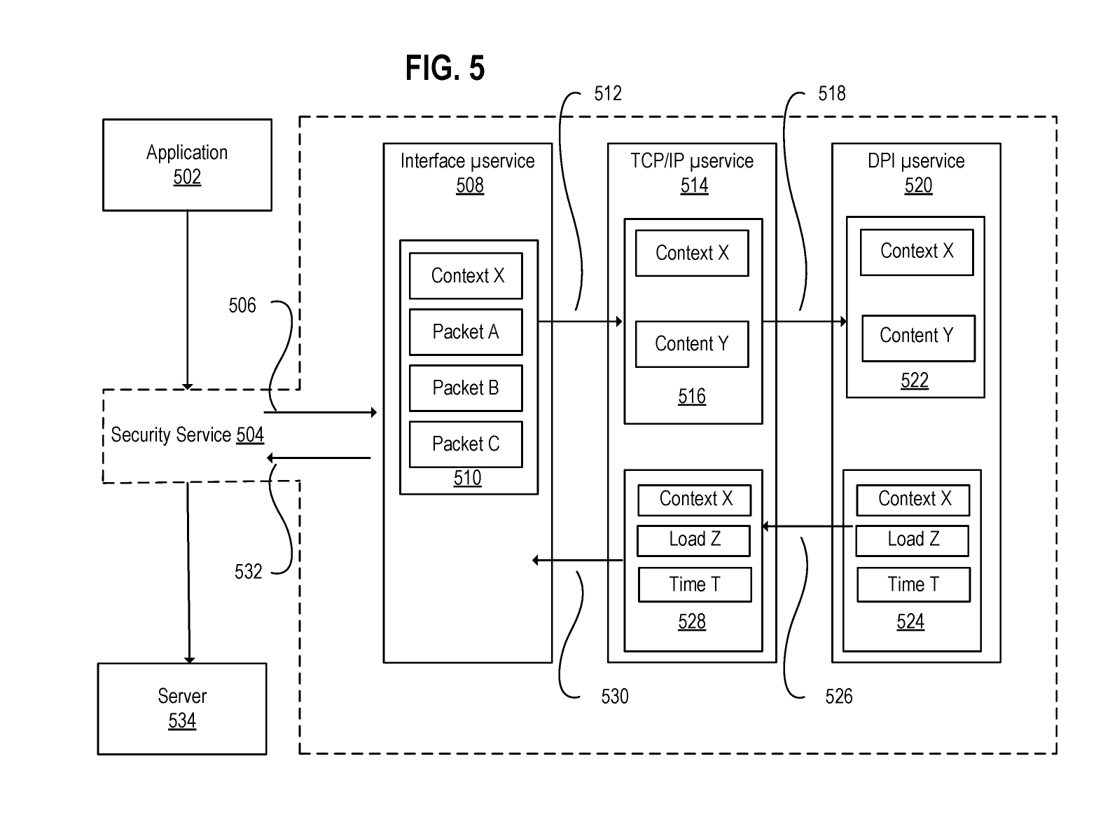

FIG. 5 is a block flow diagram illustrating application data traversing to a server after passing through a hierarchy of a security microservices according to an embodiment. As illustrated, the flow begins with security service 504 receiving a network data packet from application 502. Security service 504 forwards 506 the packet to interface microservice 508, which generates a channel data encapsulation packet 510 encapsulating three packets A, B, and C, and a context X. As shown, channel data encapsulation packet 510 encapsulates three packets, but in alternate embodiments, the number of encapsulated packets may vary without limitation. In some embodiments, context X is generated based at least on the headers of packets A, B, and C. In some embodiments, context X is generated based on a lookup of packet header fields such as Internet Protocol (IP) addresses, ports, and MAC addresses for the source and/or destination of the packets. In some embodiments, the generation of context X includes using an interface identifier obtained from a virtualization environment. Generation of context X may be accomplished through a lookup of header fields and other data in a table, a hash of header fields and other data, or another method whereby packets for which a common security policy is to be applied are associated with a common context or common portion, such as a bit field, of the context.

Context X may be considered an identifier describing the traffic streams, source machines, or applications responsible for generating packets A, B and C. This identifier may be direct (such as an ID used as a table look up), indirect (such as a pointer used to access a data structure), or some other method of instructing microservices as to the policies and processing to use for handling packets A, B, and C. As an example, context X may be generated by performing a hash, longest prefix match, or lookup of header fields such as IP addresses, TCP ports, interface names (or MAC addresses), or other packet properties. The lookup may be an exact match, longest prefix match, or other method to associate packet streams with the same security processing to use. The generated context may then be used by security services, such as a DPI service, to determine which rules to utilize when scanning the data from packets A, B, and C (and other packets that are part of the same traffic stream). This information may be embedded within the context (as a bit field or other information), available by indirection (such as a table or data structure lookup by another service), or generated programmatically based on any combination of such information.

The context may be generated through a look up at an interface microservice and is included in the transmission of packet data to transmission control protocol (TCP) reassembly services. Reassembled content from the TCP microservice is transmitted to a deep packet inspection (DPI) microservice or secure socket layer (SSL) microservice, and with the same context. By maintaining this context in the encapsulation of data transport throughout the microservice hierarchy, processing directives associated with a context become a shared read-only resource (relative to the microservices) and may only rarely use stateful updates.

Interface microservice 508 transmits 512 the channel data encapsulation packet 510 to TCP/IP microservice 514. As shown, the channel data encapsulation packet 516 includes context X and content Y, which corresponds to packets A, B, and C of channel data encapsulation packet 510. After conducting security processing of the channel data encapsulation packet 516, TCP/IP microservice 514 transmits 518 the packet to DPI microservice 520. As shown, the channel data encapsulation packet 522 includes context X and content Y, which corresponds to packets A, B, and C of channel data encapsulation packet 510. After conducting security processing of the channel data encapsulation packet 522, DPI microservice 520 generates channel data encapsulation packet 24, which, as shown, includes context X, DPI load Z, and DPI timestamp T. Encapsulated channel data may be tagged with properties including a timestamp and a load metric. The timestamp may reference the duration of microservice processing, the time at which microservice processing started or another temporal property associated with processing the encapsulated channel data. The load metric may reference the relative or absolute loading of a microservice processing the encapsulated channel data.

As shown, a DPI microservice 520 transmits, via path 526, channel data encapsulation packet 524 to TCP/IP microservice 514, which uses the DPI load and DPI timestamp information to inform future load-balancing decisions. As shown, a TCP/IP microservice 514 generates channel data encapsulation packet 528, which includes context X, TCP/IP load Z, and TCP/IP timestamp T. As shown, TCP/IP microservice 514 transmits, via path 530, channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits the packets to a server 534.

As shown, DPI microservice 520 transmits channel data encapsulation packet 524 to TCP/IP microservice 514, which uses the DPI load and DPI timestamp information to inform future load-balancing decisions. As shown, TCP/IP microservice 514 generates channel data encapsulation packet 528, which includes context X, TCP/IP load Z, and TCP/IP timestamp T. As shown, TCP/IP microservice 514 transmits channel data encapsulation packet 528 to interface microservice 508, which uses the TCP/IP load and TCP/IP timestamp information to inform future load-balancing decisions. The flow is completed when interface microservice 508 transmits, via path 532, packets to security service 504, which transmits them to server 534 microservice.

Exemplary benefits of the security service 504 may include the ability of each microservice to utilize the same channel data encapsulation protocol for all communication, thereby allowing scaling across the entirety of the datacenter network routable via the channel data encapsulation header. Communications between microservices maintain a context X generated at interface microservice 508 to all subsequent microservices that no longer have access to the original packets. As an example, a DPI microservice processing content reassembled by a TCP/IP microservice has no visibility into the packets used by the TCP/IP microservice to reassemble the content. However, the context X generated upon reception of one or more of those packets at the interface microservice, forwarded to the TCP/IP microservice and subsequently forwarded by the TCP/IP microservice to the DPI microservice, may be used to determine policy or select a minimal DPI signature set by the DPI microservice without incurring additional state processing. By providing load and timestamp data in the channel data encapsulation packets 524 and 528, which are returned via paths 526 and 530, the microservices receive and can maintain real-time loading and processing latency information utilized to make load balancing decisions.

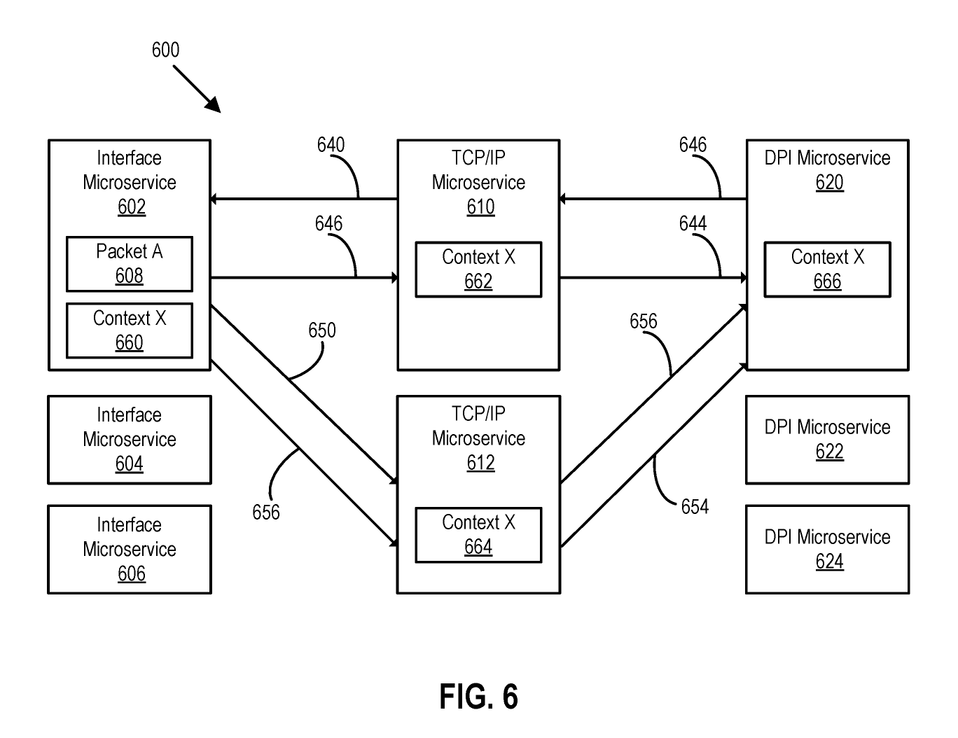

FIG. 6 is a block diagram illustrating a flow of application data through a stateless processing, fault-tolerant microservice environment in accordance with disclosed embodiments. As illustrated, security system 600 includes interface microservices 602, 604, and 606, TCP/IP microservices 610 and 612, and DPI microservices 620, 622, and 624. Other examples include a different number of microservices and/or a different number of microservice types. In the example of FIG. 6, an interface microservice 602 receives packet A 608, and generates a context X 660.

One benefit of the security system illustrated in FIG. 6 is the handling of state. For example, if packets belong to a certain context X, the security system 600 may enable both TCP/IP microservices 610 and 612 to perform meaningful work on the packets. By implementing TCP/IP processing as microservices 610 and 612 with an external state structure and a context that accompanies processed data, each TCP/IP microservice, and any other microservice at every level of the security hierarchy, can be isolated from other microservices and can be scaled independently. Each microservice can access the state for any packet or reassembled packet data, thereby enabling real-time load balancing. In many cases, the context enables microservices to forego consulting service state (state associated with processing at the hierarchy level of the specific microservice), thereby reducing the demands on the global state repository.

As an example, consider the context X 662 obtained by TCP/IP microservice 610 as part of packets received from interface microservice 602 as transmission 646. Context X 662, when transmitted to DPI microservice 620 as part of transmission 644, along with the reassembled packet data, contains information that may enable the DPI microservice to forego or simplify processing of this reassembled data. Such information can include, for example, a context bit or field specifying a subset of regular expressions or patterns to be used for DPI processing, a number of bytes of reassembled data to be received before beginning DPI processing, specific allowed or disallowed protocols, and other information potentially avoiding a DPI state lookup.

In an embodiment, microservices of a security system 600 are stateless. For example, each of the microservices may retrieve state information from an outside source such that the microservice can process packets or content belonging to any context. Each microservice may retrieve and update service state (that state associated with the microservice processing). Additionally, each microservice may retrieve and update context state (state associated with the context relevant for all security service processing). In some embodiments, the process state and context state share a global state service. Examples of elements of context state include a level of suspicion regarding traffic from a source IP, a policy to ignore certain ports or protocols, and other information used to process the packets, reassembled content, and extracted objects from communication identified with the context.

In an embodiment, multiple microservices in the same or different hierarchy of the security system may be able to process packets associated with the same context at the same time. If one security microservice fails (e.g., if a TCP microservice fails to respond to a request), another microservice can take over and process the request using the failed microservice's context.

Returning to FIG. 6, the generation of context X 660 may include considering properties associated with a packet A 608 (e.g., such as an n-tuple detailing routing information), and also a state lookup or a context lookup, in addition to other information. Interface microservice 602 provides packet A 608 and context X 660 to TCP/IP microservice 610 or 612 via path 640 or 650, respectively. For example, interface microservice 602 may conduct a load-balancing to select one of the TCP/IP microservices to forward the packet A 608 and the context X 660.

In an embodiment, TCP/IP microservices 610 and 612 are stateless, but may benefit from the context X generation performed by interface microservice 602. For example, whichever of TCP/IP microservices 610 and 612 receives packet A may disassemble the packet to extract the data associated with the packet and conduct security processing on the data. TCP/IP reassembly generally consists of associating packets with flows (e.g., identified by source and destination IP and port values) and using the TCP sequence numbering to place the packets into a correct order, remove any overlap or duplication, and/or identify missing or out of order packets.

In FIG. 6, TCP/IP microservices 610 or 612 forward the extracted data and/or the data resulting from the security processing to DPI microservice 620 via paths 644 or 656, respectively. Along with the transmitted data, TCP/IP microservice 610 or 612 forwards context X 662 or 664, respectively, to a DPI microservice 620. In some embodiments, context X 660, 662, 664, and 666 are substantially identical.

In an embodiment, DPI microservice 620 is also stateless and may use the context provided by TCP/IP microservice 610 or 612 in transmission 644 or 656. DPI microservice 620 may load DPI processing state before processing the received data, but can perform some work (e.g., scheduling different DPI pattern state tables) based on the context. Transmitting the context to the DPI microservice therefore may obviate some amount of work by the DPI microservice. If TCP/IP microservice 610 fails and interface microservice 602 instead utilizes TCP/IP microservice 612, DPI microservice 620 may obtain the context from the transmission of reassembled TCP content in transmission 656.

Although FIG. 6 does not show a second packet, when a subsequent packet associated with the same context is received, interface microservice 602 may conduct a load balancing and select one of the TCP/IP microservices to forward the packet along with context X 660. In one embodiment, interface microservice 602 chooses to forward the second packet to TCP/IP microservice 612 via path 650. TCP/IP microservice 612 performs some security processing, then transmits the second packet and context X 664 to DPI microservice 620 via path 654. After performing some security processing, DPI microservice 620 responds to TCP/IP microservice 612 via path 654, and TCP/IP microservice responds to interface microservice 602 via path 656.

Summarizing the operation of an embodiment as illustrated by FIG. 6, an interface microservice transmits packets to a TCP/IP microservice along with a context that has been generated based on the contents of the packets. The transmission comprises a request to perform a security service (e.g., TCP/IP reassembly) for the packets to generate reassembled data. The TCP/IP microservice consults the received context to determine whether to obtain a context state, service state, or both, from a state repository to perform the security service. Reassembly is performed by the TCP/IP microservice, any modified state returned to the state repository and the reassembled data transmitted, along with the context, to a DPI microservice as a request to perform DPI processing.

Continuing the example illustrated by FIG. 6, the DPI microservice receives the reassembled data and context from the request to perform DPI security services transmitted by the TCP/IP microservice. The DPI microservice consults the received context to determine whether to obtain a context state, service state, or both, from a state repository to perform its security service. DPI inspection may be performed by the DPI microservice, any modified state returned to the state repository, and a response sent to the TCP/IP microservice.

### 2.2. Microservices for Intercepting Network Traffic

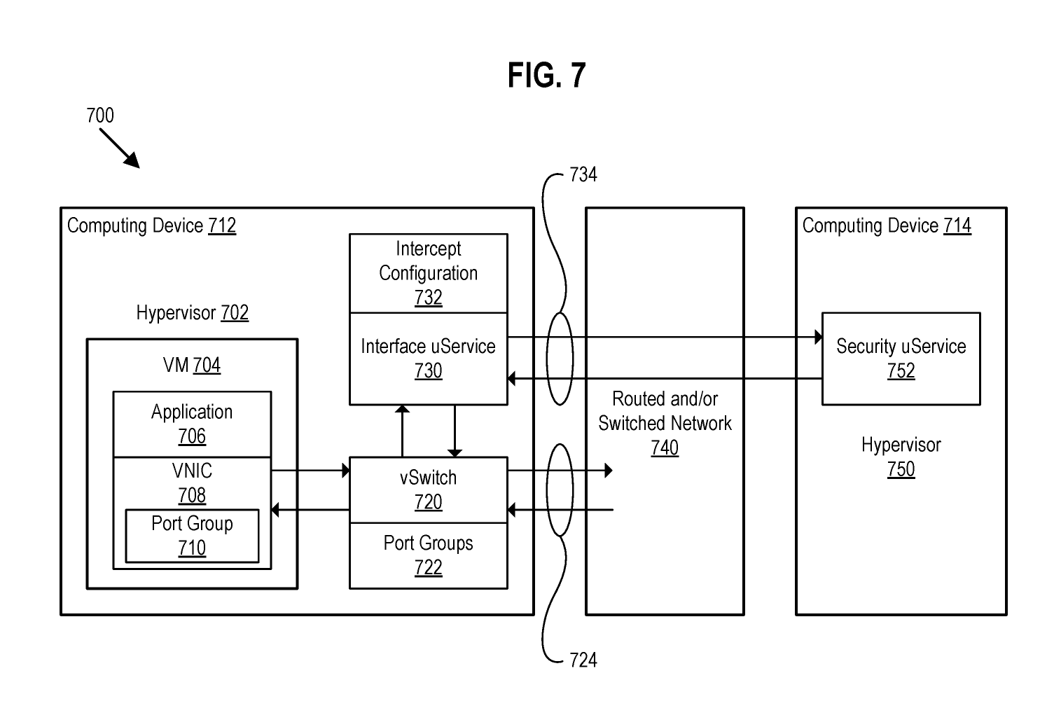

FIG. 7 is a block diagram illustrating an example system for using an interface microservice to intercept network traffic routed by a virtual switch (vSwitch) in accordance with the disclosed embodiments. In an embodiment, a system 700 includes at least one computing device 712 coupled to at least one other computing device 714 via a routed and/or switched network 740. The routed and/or switched network 740, for example, might be a network within a data center interconnecting various types of devices within the data center, or any other type of network connecting computing devices 712, 714. FIG. 7 represents an example embodiment that is provided for purposes of illustrating a clear example; other embodiments may use different arrangements.

In an embodiment, a computing device 712 includes a hypervisor 702, vSwitch 720, and an interface microservice 730. The hypervisor 702 is a component implemented in software, hardware, firmware, or combinations thereof, and which manages the creation and operation of one or more virtual machines (VMs) (e.g., a VM 704). Examples of a hypervisor 702 include, but are not limited to, a VMware® ESX™/ESXi™ hypervisor, a Citrix® XenServer® hypervisor, or a Microsoft® Hyper-V® hypervisor. In some embodiments, vSwitch 720 and port groups 722 are integrated into or otherwise part of hypervisor 702, configured via hypervisor 702, or some combination thereof.

In an embodiment, a VM 704 running on a hypervisor 702 is generally any type of emulated computer system that can share hardware resources with one or more other VMs running on the hypervisor 702. In the example of FIG. 7, a VM includes at least one application 706 and at least one virtual network interface card (VNIC) 708. Examples of an application 706 include, but are not limited to, an operating system, a system application, and a user application.

In an embodiment, a VM 704 is one of a plurality of VMs networked as part of a virtual network. The plurality of VMs can be networked in part using one or more vSwitches (e.g., vSwitch 720). Whereas a physical Ethernet switch manages network traffic between machines on a physical network, a vSwitch manages network traffic between VMs logically connected to virtual ports of the vSwitch. A vSwitch can be connected to other vSwitches and to one or more physical switches (not shown in FIG. 7) using physical Ethernet adapters to join virtual networks with physical networks. For example, the network path 724 might connect the vSwitch 720 to a routed and/or switched network 740 via one or more physical switches.

In an embodiment, a VNIC 708 of a VM 704 is connected to a port of the vSwitch 720, and the port can be assigned to a port group 710. At a high level, a port group is a vSwitch configuration which defines a logical grouping of VNICs connected to the ports comprising the group. For example, a system 700 might include any number of VMs 704 having any number of VNICs 708, and the VNICs can be grouped into any number of port groups by the vSwitch 720. A port group can be further associated with configuration options applied to the member ports including, for example, bandwidth limitations, traffic shaping rules, and other settings. In an embodiment, a vSwitch 720 stores configuration information related to port groups as port groups configuration 722. Based on the port groups configuration 722, for example, when a vSwitch 720 receives a packet from a VNIC of a VM, the vSwitch 720 can determine which port group the VNIC is associated with and tag the packet with a VLAN assigned to the port group in the configuration.

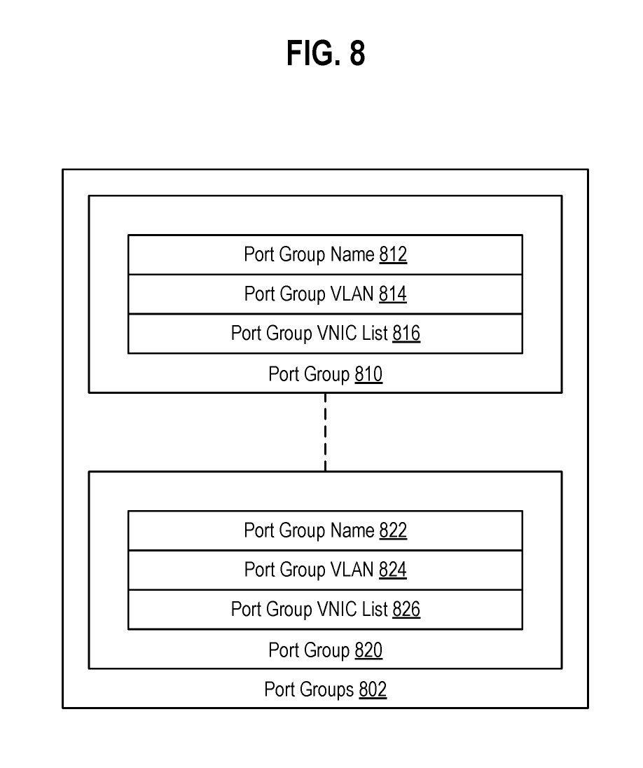

FIG. 8 is a block diagram illustrating an example set of port group definitions, as shown in FIG. 7, in accordance with the disclosed embodiments. For example, the port groups configuration 802 shown in FIG. 8 includes the port group definitions 810, 820. In one embodiment, a port group definition includes a port group name (e.g., port group name 812, 822), a port group VLAN (e.g., port group VLAN 814, 824), and a port group VNIC list (e.g., port group VNIC lists 816, 826). A port group name is an optional label for the port group, the port group VLAN identifies a VLAN associated with the port group, and the port group VNIC list identifies a set of VNICs belonging to the port group. The example port group configuration as shown in FIG. 7, for example, can be part of port groups configuration 722 stored at a vSwitch 720, as shown in FIG. 7.

As described in more detail herein, an interface microservice 730 enables network traffic sent to and received from a VM 704 (and any other VMs generating network traffic routed by vSwitch 720) to be intercepted and filtered based on an intercept configuration 732. As shown in FIG. 7, an interface microservice 730 can optionally send, via network path 734, intercepted network traffic to a security microservice 752 running on a separate computing device 714. The computing device 714, for example, includes a separate hypervisor 750 and may further include any number of VMs running on the hypervisor 750. In other examples, an interface microservice 730 can perform various security operations locally at the computing device 712 without sending the intercepted network traffic to a separate computing device 714.

In one embodiment, a microservice as depicted in FIG. 7 (e.g., interface microservice 730 or security microservice 752) is implemented using a software “container,” where a container is an isolated user space instance within a virtualization environment in which the kernel of an operating system allows for the existence of multiple isolated user-space instances. In other examples, a microservice is implemented by a virtual machine instance, a thread of execution, a standalone software application, or any other type of computer-executable logic.

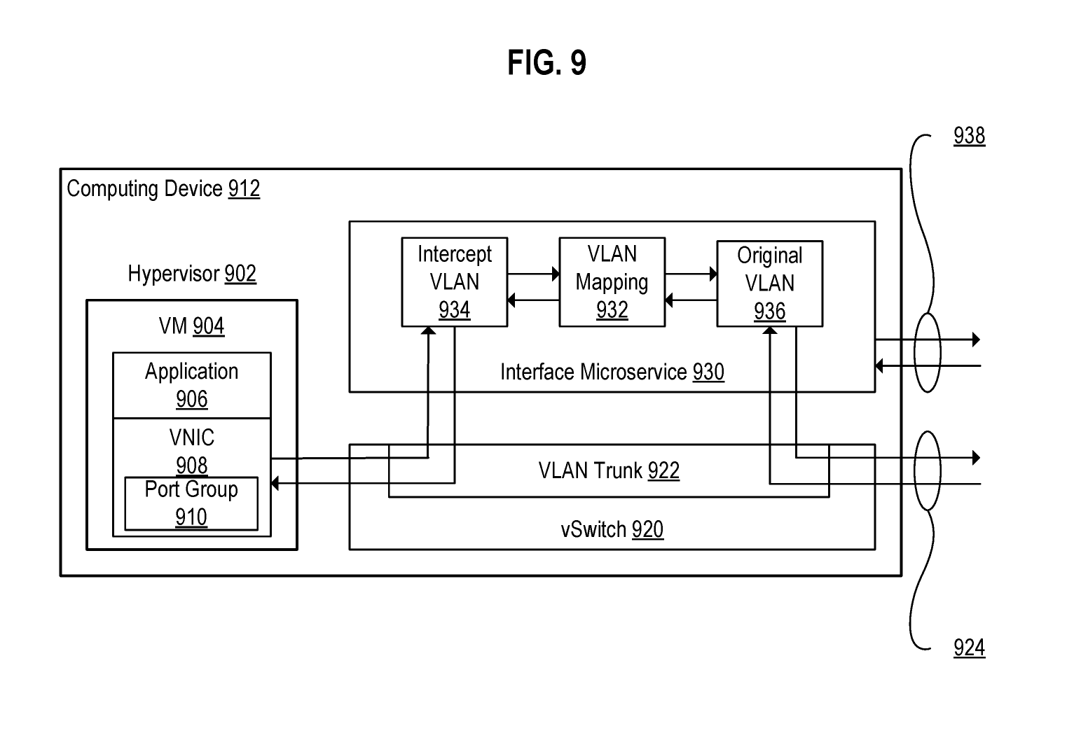

FIG. 9 is a block diagram illustrating an example interface microservice configured to intercept network traffic routed by a vSwitch in accordance with the disclosed embodiments. In FIG. 9, for example, an interface microservice 930 on a computing device 912 intercepts network traffic routed by a vSwitch 920 (e.g., network traffic sent and received by a VM 904 via VNIC 908). When the VNIC 908 sends a network packet (e.g., based on a request generated by an application 906 or other source), the VM 904 includes an identifier of the port group 910 with the network packet. If the interface microservice 930 was not present in FIG. 9, the network packets including the port group 910 identifier arrive at the vSwitch 920, the vSwitch 920 determines a VLAN to which the port group 910 is assigned, and sends the network packet out network path 924 based on the determined VLAN.

In an embodiment, a VLAN assigned to a port group 910 as in the example above is referred to as an “original” or “existing” VLAN. In one embodiment, to enable an interface microservice 930 to intercept network traffic routed by the vSwitch 920, the microservice creates a new VLAN, referred to herein as an “intercept” VLAN, for each original VLAN and further generates and stores a VLAN mapping 932 indicating a mapping from each original VLAN to a respective intercept VLAN. The interface microservice 930 further adds the original VLAN and the intercept VLAN to a VLAN trunk 922 enabling the traffic on both VLANs to be routed to an interface microservice 930.

In an embodiment, based on the configuration described above, the interface microservice 930 can change the VLAN assigned to port group 910 of VM 904 from the original VLAN to the intercept VLAN and, consequently, packets sent from VM 904 are directed to interface microservice 930 via the VLAN trunk 922. The interface microservice 930 can then translate the intercept VLAN 934 to the original VLAN 936 using the VLAN mapping 932, and network traffic leaving network path 924 can be associated with the original VLAN.

Similarly, when a network packet is received by the vSwitch 920 coming in from the network path 924, because the interface microservice 930 is now part of the VLAN trunk 922 for both the intercept VLAN and the original VLAN and the incoming network packets are associated with the original VLAN, the network packets are routed to the interface microservice 930. The interface microservice 930 similarly maps the original VLAN to the intercept VLAN using the mapping 932, and the packets are sent to the VM 904 using the VLAN trunk 922. In this manner, the changes to the network structure at the hypervisor 902 and vSwitch 920 are transparent to outside devices which only are aware of the original VLAN.

### 3.0. FUNCTIONAL OVERVIEW

Approaches, techniques, and mechanisms are disclosed that enable a computer security application to intercept, filter, and perform security operations on network traffic sent from and received by VMs in a networked computing environment. In one embodiment, a computer security application configures a vSwitch to enable traffic routed by the vSwitch to be intercepted and filtered by an interface microservice. The interface microservice receives, from the vSwitch, configuration information including a mapping between at least one port group identifier and at least one VLAN identifier. For each existing, or “original,” VLAN identifier in the configuration information, the interface microservice creates a separate “intercept” VLAN. The interface microservice adds the at least one existing VLAN, the at least one intercept VLAN, and the interface microservice to a VLAN trunk. The configuration information is modified to replace the existing VLAN identifiers associated with the port groups with identifiers of the intercept VLANs.

In an embodiment, based on the configuration described above, an interface microservice can receive and filter traffic routed by a vSwitch and configured with the intercept VLANs. For example, a vSwitch receiving network packets associated with an intercept VLAN routes the packets to the interface microservice via the VLAN trunk created above. The interface microservice can retrieve and apply various packet filters stored in association with the intercept VLAN to the network packets. If the packet filters match any of the intercepted network packets, the interface microservice can perform various security operations on the packets, send the network packets for security processing by an external microservice, or perform any other operations. Otherwise, the microservice can send network packets not matching the retrieved packet filters to the intended destination based on an original VLAN identifier stored in an intercept to original VLAN mapping.

In an embodiment, an interface microservice is an executable component of a computer and network security system, such as the system described in Section 2.0. As illustrated in FIG. 7, for example, an interface microservice 730 configures a VM 704 and vSwitch 720 to route traffic through the interface microservice 730 to be filtered based on intercept configuration 732. In an embodiment, network traffic matching a filter can be processed locally, or sent to an external security microservice 752 for additional security operations. For example, a security microservice 752 can perform operations to determine whether network traffic matching the filter poses a potential security threat to computing device 712 or other devices.

### 3.1. Configuring a vSwitch for Traffic Interception

In an embodiment, security services provided to VM 704 include intercepting and analyzing network traffic traversing a network path 724. At a high level, an interface microservice 730 works with a vSwitch 720 to provide security services by filtering intercepted network packets, and by locally processing filtered packets or sending the filtered packets to one or more higher level security services via network path 734. The higher level security services might reside on a different virtual machine on the same local physical machine, at another physical machine, or at any location accessible to an interface microservice 730.

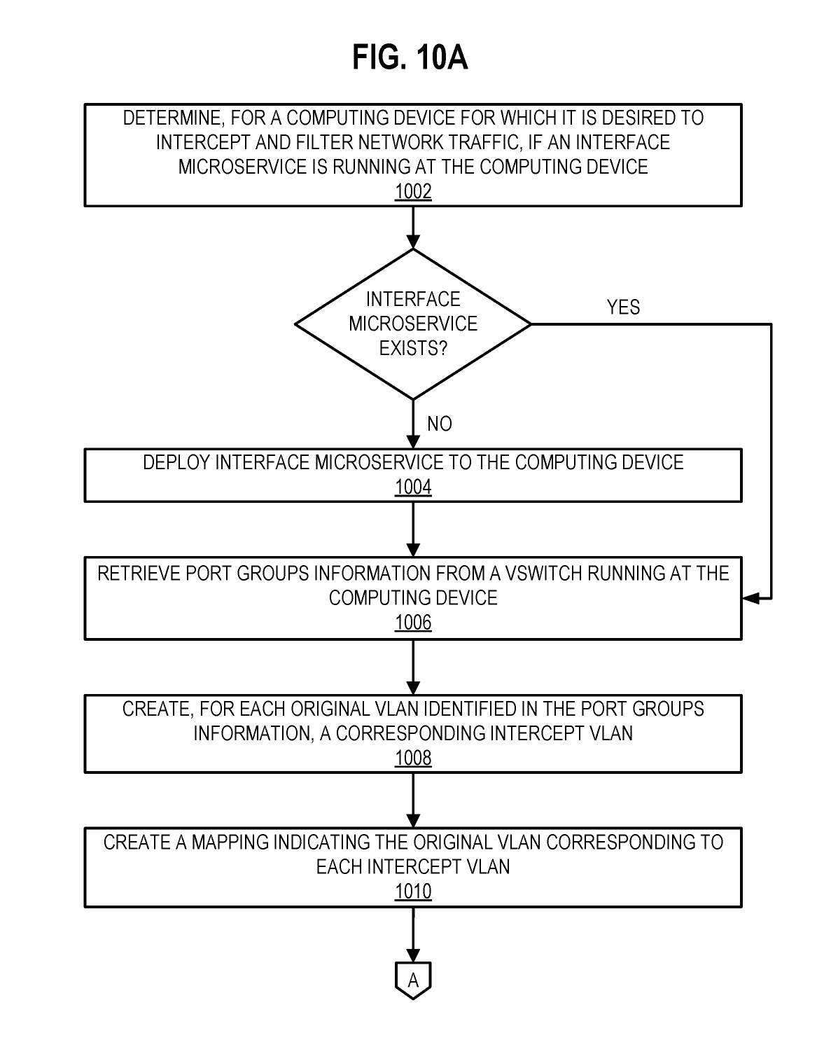

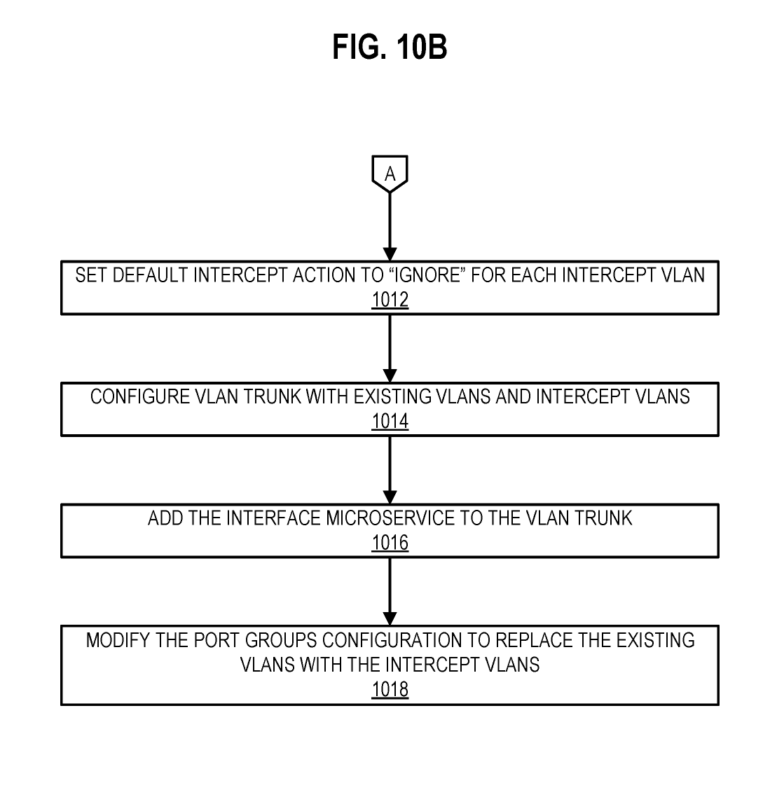

FIGS. 10A, 10B illustrate embodiments of a method of configuring a vSwitch to enable an interface microservice to intercept and filter network traffic routed by the vSwitch. At a high level, the method in FIGS. 10A, 10B describes inserting an interface microservice into a packet flow managed by a vSwitch in a way that is transparent to devices outside of the local area network(s) managed by the vSwitch. As described in more detail hereinafter, by enabling an interface microservice to transparently intercept network traffic at a vSwitch, the interface microservice can efficiently filter network traffic and determine whether to perform additional security operations on network traffic at the packet level. Although FIGS. 10A, 10B describes operations performed by a configuration microservice (e.g., a configuration microservice 202), some or all of the operations described in FIGS. 10A, 10B can be performed by a configuration microservice, an interface microservice (e.g., an interface microservice 730), another type of microservice, an application, or any other computer-executable logic. In one embodiment, some or all of the operations described in FIGS. 10A, 10B are performed by a configuration element within a security service or security orchestrator.

At block 1002, a configuration microservice determines, for a computing device for which it is desired to intercept and filter network traffic, if an interface microservice is running at the computing device. At block 1004, if an interface microservice is not currently running on the computing device, the configuration microservice installs an interface microservice (e.g., an interface microservice 730). Otherwise, if an interface microservice is currently running on the computing device, the method proceeds to block 1006.

In an embodiment, the computing device for which it is desired to intercept and filter network traffic includes at least one hypervisor, and at least one VM is running on the at least one hypervisor. As illustrated in FIG. 7, for example, a computing device 712 might include at least one hypervisor 702, where at least one VM 704 is running on the hypervisor. The at least one VM includes a VNIC 708 that is connected to a port of a vSwitch, which routes network traffic for a plurality of VNICs connected to the vSwitch.

In an embodiment, the vSwitch is associated configuration information which includes, for example, a port groups configuration 722. The port groups configuration 722 includes information defining one or more port groups managed by the vSwitch, where each port group is associated with a set of member VNICs. For example, one port group of port groups configuration 722 might include VNIC 708 and some number of other VNICs of the VM 704 or other VMs. The port groups configuration 722 includes a VLAN associated with each port group.

At block 1006, the interface microservice retrieves port groups information from the configuration for the vSwitch running on the computing device. As indicated above, the port groups configuration 722 indicates, for each port group, which VNICs (and associated VMs) are members of the port group and further identifies a mapping with an associated VLAN. In one embodiment, the set of VLANs associated with the port groups defined in a port groups configuration 722 of a vSwitch 720 is referred to herein as a set of existing, or original, VLANs.

At block 1008, the configuration microservice creates, for at least one original VLAN identified in the port groups information, a corresponding intercept VLAN. For example, for each original VLAN associated with a port group from port groups configuration 722 of vSwitch 720, a configuration microservice can create a corresponding intercept VLAN. In general, each of the intercept VLANs created at block 1008 represents an internal version of a corresponding original VLAN and can be used to route the original VLAN traffic to an interface microservice 730, as further described in the following operations.

At block 1010, the configuration microservice creates a mapping indicating the original VLAN corresponding to each intercept VLAN created at block 1008. In one embodiment, the mapping is stored by the interface microservice 730 (e.g., illustrated in FIG. 9 as VLAN mapping 932) such that an interface microservice 730 can translate network packets associated with an original VLAN into packets associated with an intercept VLAN, and vice versa. The process of FIG. 10A proceeds to block 1012 in FIG. 10E3 via off-page connector A).

At block 1012, the configuration microservice optionally sets a default intercept action to “ignore” for each created intercept VLAN. For example, a configuration microservice might configure an interface microservice 730 initially to ignore network packets routed by a vSwitch 720 until further security processing is desired. In effect, setting an interface microservice's intercept action to “ignore” causes the interface microservice to operate in a “pass-through” mode, whereby packets received by the microservice are passed through the interface microservice without processing. In this example, an interface microservice 730 receives network packets associated with an intercept VLAN, translates the intercept VLAN to an original VLAN, and causes the network packets to be sent out a network path 724. In this manner, other networked devices receiving the network packets via network path 724 can be unaware of the intercept VLAN originally associated with the network packets.

At block 1014, the configuration microservice configures a VLAN trunk to include the original VLANs and the intercept VLANs. At a high level, a VLAN trunk is a network link used to carry traffic for multiple VLANs and to operate as a single logical link for multiple virtual links. In an embodiment, the VLAN trunk configured at block 1014 is able to carry traffic for both the original VLANs and the intercept VLANs created at block 1008. As described above, network traffic can be associated with a particular VLAN based on a VLAN tag included with the network packets (e.g., by a VM 904 originating a network packet, an interface microservice 930 intercepting a network packet, or another device).

At block 1016, the configuration microservice adds the interface microservice to the VLAN trunk. In an embodiment, adding the interface microservice to the VLAN trunk enables the interface microservice to receive network traffic associated with either the original or intercept VLANs (e.g., network traffic associated with an intercept VLAN by a VM 904 or network traffic arriving at network path 924 associated with an original VLAN).

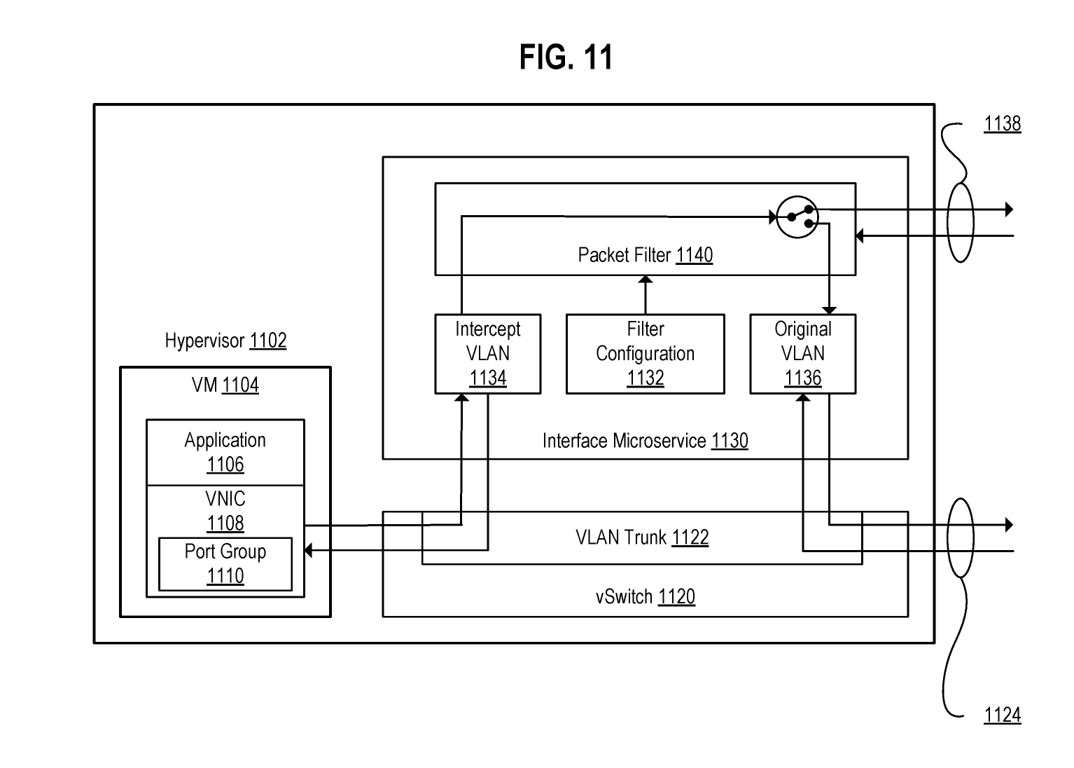

At block 1018, the configuration microservice modifies the port groups configuration at the computing device to use the intercept VLAN. For example, a configuration microservice can modify the port group 910 at a VM 904 to use the intercept VLAN mapped to the original VLAN. Based on the modification to the port group 910 configuration, the VM 904 includes a VLAN tag of the intercept VLAN with network packets sent from the VM 904. As described in more detail in reference to FIG. 11, because the network packets are associated with the intercept VLAN, the vSwitch 920 routes the traffic to the interface microservice 930 via the VLAN trunk 922.

FIG. 11 illustrates an example system with an interface microservice configured using the method described in FIGS. 10A, 10B, in accordance with the disclosed embodiments. In an embodiment, a configured interface microservice 1130 includes an interface for network traffic associated with an intercept VLAN 1134, an interface for network traffic associated with original VLAN 1136, a packet filter 1140, and a filter configuration 1132. In an embodiment, a filter configuration 1132 enables the interface microservice 1130 to filter packets coming from VM 1104 (and any other VMs connected to the vSwitch 1120) using the packet filter 1140. If the packet filter 1140 does not match an examined network packet, the interface microservice 1130 applies the original VLAN 1136 mapping to the network packet and sends the packet out network path 1124.

If the packet filter 1140 does match an examined network packet, the interface microservice 1130 can perform any operations relative to the network packet, including sending the network packet to another microservice on the same machine, sending the network packet to a security service running on another machine via network path 1138. In the example of FIG. 11, if a network packet is sent to a security service running on a separate machine, and if the security service allows the packet (e.g., because the packet did not raise any security concerns), the packet returns via network path 1138. The interface microservice 1130 can then apply the original VLAN 1136 to the network packet and send the packet out network path 1124. At a high level, a packet filter 1140 enables an interface microservice 1130 to quickly determine whether individual network packets warrant additional security processing (e.g., based on ports or IP addresses of interest, a size of the packets, etc.) before sending the network packets out to other devices. The configuration of FIG. 11 thus enables packet-level granularity for determining whether to apply additional security processing to packets arriving at the vSwitch 1120.

For example, assume a network administrator desires to check for “poisoned” SQL queries. In this example, the security administrator may configure an interface microservice 1130 to filter network traffic associated with a connection to known SQL server address, or associated with web traffic containing a SQL query, and to send the filtered network traffic to another security microservice via network path 1138. The external security process, for example, may then reassemble the network traffic, run various security checks, or perform any other processing to determine whether or not the network packets potentially carry a SQL injection attack. If the external security service determines that the network traffic is safe, the interface microservice 1130 allows the network packets to be sent out the network path 1124 to the originally intended destination. Otherwise, network packets which the packet filter 1140 determines are not related to SQL queries can bypass the additional security processing to avoid using additional computational resources at the external security service.

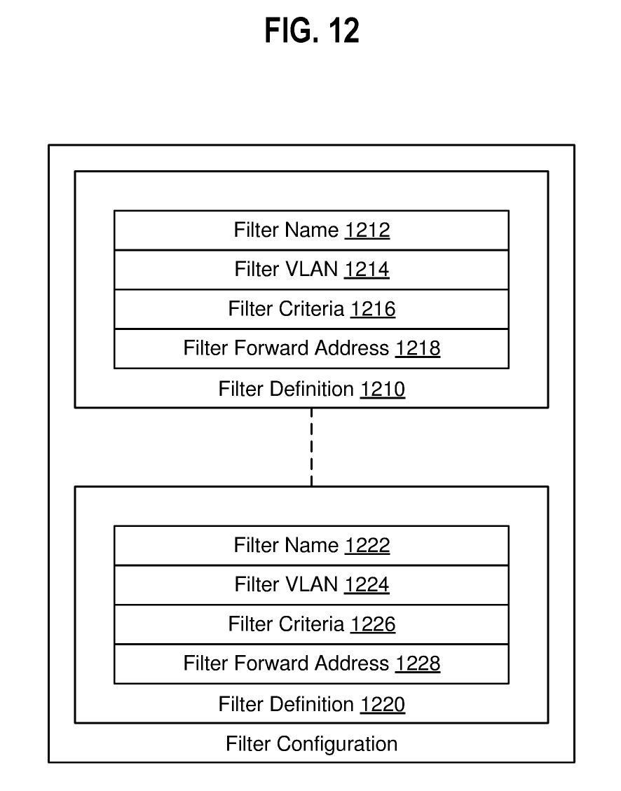

FIG. 12 is a block diagram illustrating an example of a filter configuration (e.g., a filter configuration 1132 shown in FIG. 11) in accordance with the disclosed embodiments. In general, a filter configuration 1132 can be used by an interface microservice 1130 to determine whether individual packets are subjected to additional security processing by the interface microservice 1130 or other microservices, as described above. In an embodiment, a filter definition (e.g., filter definition 1210, 1220) includes a filter name (e.g., filter name 1212, 1222), a filter VLAN (e.g., a filter VLAN 1214, 1224), filter criteria (e.g., filter criteria 1216, 1226), and a filter forward address (e.g., a filter forward address 1218, 1228).

In an embodiment, a filter name is a human-readable label for the filter (e.g., “SQL injection filter” or “DoS filter”). The filter VLAN indicates one or more VLANs to which the filter applies. For example, an interface microservice might perform packet filtering on network packets originating from multiple different VLANs, so filters can apply to particular VLANs. In some embodiments, a filter name is hierarchical such that a single human-readable label causes multiple functional filters to be employed concurrently. In some embodiments, a filter has dependencies on another filter, such that enabling a first filter causes at least one additional filter to be enabled concurrently.

In an embodiment, filter criteria include any rules, patterns, or other information used to determine whether a packet matches a filter. For example, filter criteria might include port numbers, IP addresses or IP address ranges, packet size thresholds or any other characteristic against which packets received by the microservice can be compared. In an embodiment, a forward address is a network address to which network packets are sent if the network packets match the packet filter. For example, the forward address might be an address of an external computing device which includes additional security services to be applied to packets matching the filter. As another example, a filter forward address might be a null value indicating that the filter can simply send network packets matching the filter out a default interface.

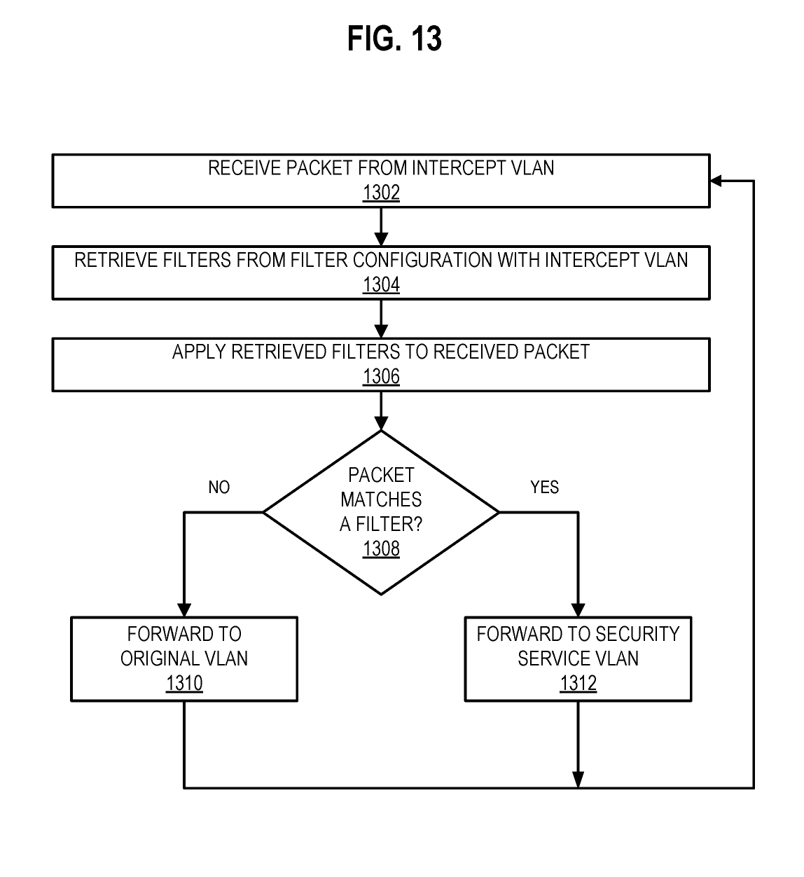

FIG. 13 illustrates embodiments of a method performed by an interface microservice to intercept and filter VLAN traffic. For example, in one embodiment, the method described in FIG. 13 can be performed by an interface microservice 1130 configured to intercept and filter network traffic based on the configuration described in reference to FIGS. 10A, 10B.

At block 1302, an interface microservice receives a packet from an intercept VLAN. For example, referring again to FIG. 11, an interface microservice 1130 might receive a packet from an intercept VLAN 1134, where the packet originates from a VM 1104 including a VNIC 1108, which is a member of the intercept VLAN 1134. The VM 1104 tags the packets sent from the VNIC 1108 with the VLAN based on the port group 1110 associated with the VNIC 1108.

At block 1304, the interface microservice identifies packet filters from a stored packet filter configuration that match the intercept VLAN. For example, an interface microservice 1130 receiving a packet tagged with an intercept VLAN can use the intercept VLAN identifier to locate packet filters associated with the intercept VLAN.

At block 1306, the interface microservice applies the identified packet filters to the received packet. In an embodiment, a packet filter applied to a packet either matches the packet or does not match the packet based on one or more criteria specified in the filter.

At block 1308, the interface microservice determines whether the packet matches the filter. If the network packet does not match the filter then, at block 1310, the interface microservice forwards the network packet to the original VLAN. If the network packet does match the filter then, at block 1312, the interface microservice forwards the packet to the address identified in the corresponding filter definition. As described above, the packet can be forwarded to another microservice on the same machine, to another machine, or any other location which can perform additional security operations on the packet to determine whether the packet is associated with any security threats.

### 3.2. Micro-Segmentation

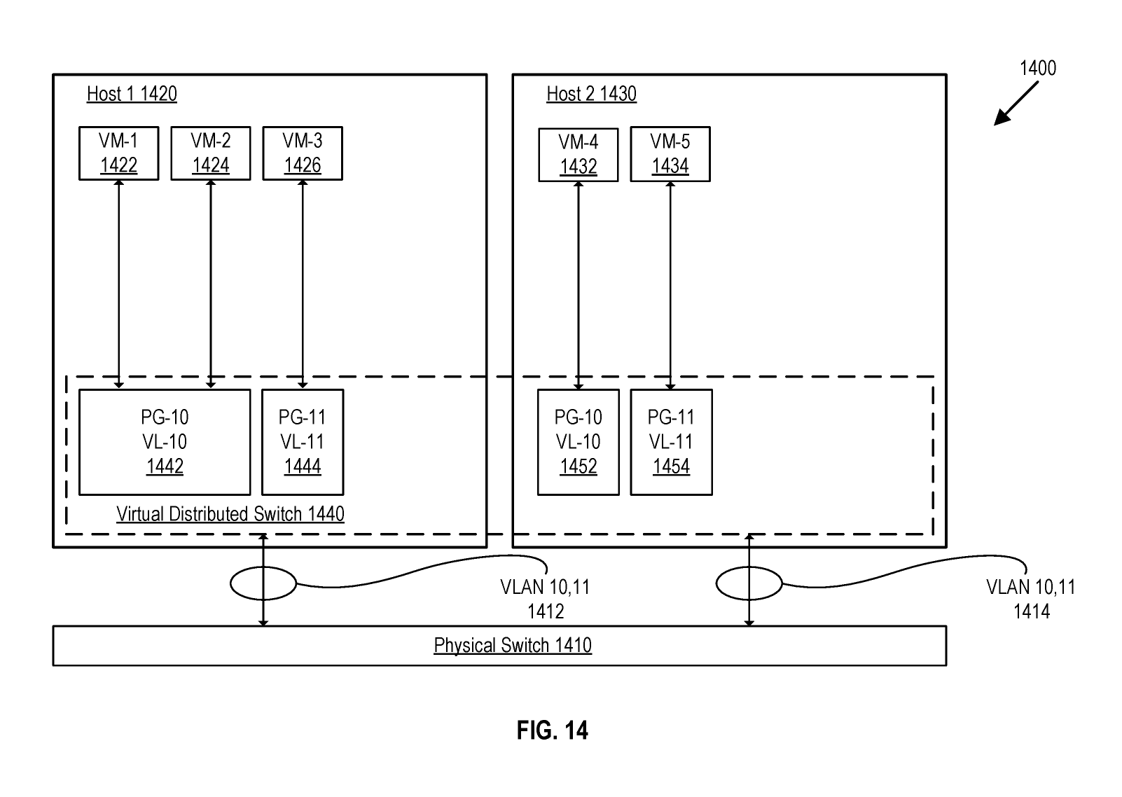

FIG. 14 is a block diagram illustrating an example system 1400 using port groups to facilitate transmission of data through a switched network environment accordance with the disclosed embodiments. FIG. 14 includes host 1 1420 and host 2 1430, each of which is connected to physical switch 1410. Each host includes one or more VMs running on the corresponding host. For example, host 1 1420 includes VM-1 1422, VM-2 1424, and VM03 1426, and host 2 1430 includes VM-4 1432 and VM-5 1434. The embodiment depicted in FIG. 14 further includes virtual distributed switch 1440 spanning across host 1 1420 and host 2 1430, which provides an abstraction of physical switch 1410 to the VMs (e.g., 1422-1426 and 1432-1434). Virtual distributed switch 1440 also provides the switching among the VMs and provides the tunneling that is required to send data from VMs to physical switch 1410. In one embodiment, a VM in Host 1 1420 send packets to virtual distributed switch 1440 for transmission to another host (e.g., Host 2 1430), and virtual distributed switch 1440 transmits the packets to physical switch 1410 over a VLAN (e.g., VLAN 10, 11 1412). In one embodiment, each VM is assigned to a port group (PG) managed by virtual distributed switch 1440, allowing VMs to be managed across multiple hosts. For example, in FIG. 14, VM-1 1422, VM-2 1424, and VM-4 1432 are assigned to PG-10 1442/1452, and VM-3 1426 and VM-5 1434 are assigned to PG-11 1444/1454.

In one embodiment, port groups perform the VLAN sequestration of VMs that are expected to communicate with each other. For example, when virtual distributed switch 1440 receives network traffic from one of VM-1 1422, VM-2 1424, and VM-4 1432 (e.g., the VMs in PG-10), virtual distributed switch 1440 identifies that the message will be communicated to physical switch 1410 using VLAN 10 1412, which is the VLAN assigned to PG-10, and assigns VL-10 to the traffic. Similarly, messages between VM-3 1426 and VM-5 1434 (e.g., the VMs in PG-11) are communicated between virtual distributed switch 1440 and physical switch 1410 using VLAN 11 1412. Because they are using different VLANs, the traffic between VMs in PG-10 and VMs in PG-11 are sequestered from each other.

In one embodiment, the presence of PG-10 1442 and 1452 in host 1 1420 and host 2 1430, respectively, facilitates the efficient migration of VMs. For example, assuming VM-1 1422 is to be migrated from host 1 1420 to host 2 1430, because PG-10 1452 is present in host 2 1430, VM-1 1422 connects with PG-10 1452, and maintains its ability to communicate with VM-2 1424 and VM-4 1432 (e.g., the other VMs in its port group).

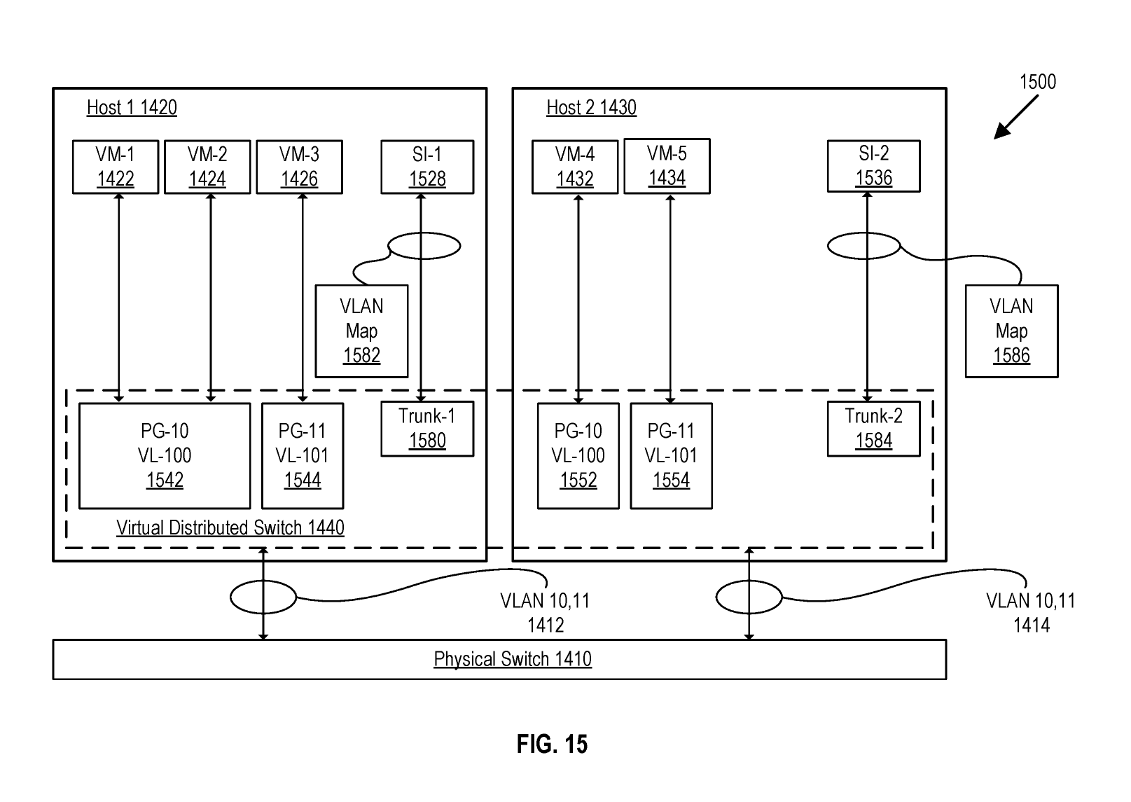

FIG. 15 is a block diagram illustrating an example system 1500 including microservices to intercept and perform security actions on network traffic in accordance with the disclosed embodiments. FIG. 15 includes host 1 1420 and host 2 1430, each of which is connected to physical switch 1410. FIG. 15 includes virtual distributed switch 1440 spanning across host 1 1420 and host 2 1430, which provides the switching among the VMs and the tunneling that is required to send data from VMs to physical switch 1410. Each host includes one or more VMs running on the corresponding host. For example, host 1 1420 includes VM-1 1422, VM-2 1424, and VM03 1426, and host 2 1430 includes VM-4 1432 and VM-5 1434. VM-1 1422, VM-2 1424, and VM-4 1432 are assigned to PG-10 1542/1552, and VM-3 1426 and VM-5 1434 are assigned to PG-11 1544/1554. Unlike system 1400 in FIG. 14, PG-10 1542/1552 and PG-11 1544/1554 are not directly assigned to VLANs corresponding to VLANs 10/11 1412 used to communicate between virtual distributed switch 1440 and physical switch 1410. Instead, PG-10 1542/1552 is assigned VL-100 and PG-11 1544/1554 is assigned VL-101.

System 1500 also includes segment interfaces (SI), trunk ports, and VLAN Maps. In one embodiment, SIs are microservices (e.g., microservices 108-122 in FIG. 1). As depicted in FIG. 15, host 1 1420 includes SI-1 1528 connected to Trunk-1 1580, and host 2 1430 includes SI-2 1536 connected to Trunk-2 1584. SI 1528 and SI 1536 implement VLAN Maps 1582 and 1586. Respectively. VLAN Maps 1582 and 1586 each maintain a mapping between the VLAN assigned to a port group and the VLAN used by virtual distributed switch 1440 for communications with physical switch 1410. In one example, VLAN Map 1582/1586 maps VL-100 to VL-10 and maps VL-101 to VL-11.

An SI acts as a programmable packet inspection and switching element and comprises the logical ingress and egress of packets for a security service. In one embodiment, the SI is configured as a pass-through monitor that allows all packets received from a trunk to be transmitted back to the trunk with the applied VLAN mapping. In one embodiment, pass-through monitoring does not preclude generating copies of each traversing packet for passive inspection and analysis by other security microservices. In one embodiment, an SI configured as an active monitor redirects some or all packets received from a trunk to other security services and subsequently forwards packets allowed by the security services back to the trunk. In one example, the trunk and its constituent ports is a grouping configuration of a switch and directs packets of certain VLANs or other distinguishing characteristics out of the switch via its constituent ports.

The trunk ports intercept the traffic sent by VMs prior to the traffic being sent to physical switch 1410. For example, when VM-1 1422 sends traffic to PG-10 1542 in virtual distributed switch 1440, the traffic is assigned to VL-100. Prior to virtual distributed switch 1440 sending the traffic to physical switch 1410, the traffic is intercepted by Trunk-1 1580 and sent to SI-1 1528. SI-1 1528 uses VLAN Map 1582 to modify the VLAN associated with the traffic. Continuing the example, SI-1 1528 maps the traffic from VM-1 1422, initially associated with VL-100, to VL-10, and routes the traffic out to physical switch 1410 across VLAN 10 1412. Similarly, when traffic is sent from physical switch 1410 to virtual distributed switch 1440 on host 1 1420 across VLAN 10 1412, the traffic is routed to Trunk-1 1580, and then to SI-1 1528. SI-1 1528 uses VLAN Map 1582 to modify the VLAN associated with the traffic from VL-10 to VL-100. In addition, Trunk-2 1584, SI-2 1536, and VLAN Map 1586 perform similar processes with respect to network traffic involving VMs in host 2 1430.

In one embodiment, in addition to performing the VLAN mapping, SI-1 1528 performs security actions on the traffic, or passes the data to one or more other microservices (e.g., microservices 108-122 in FIG. 1) to perform security action. In one embodiment, when traffic is sent from a VM to another VM within a same port group, the traffic is not intercepted by the trunk and passed to the segment interface. For example, data passing from VM-1 1422 with the destination being another VM associated with the same port group VM-2 1424 is not intercepted. This presents potential security issues, as traffic sent between VMs associated with the same port group is not monitored or evaluated for security threats.

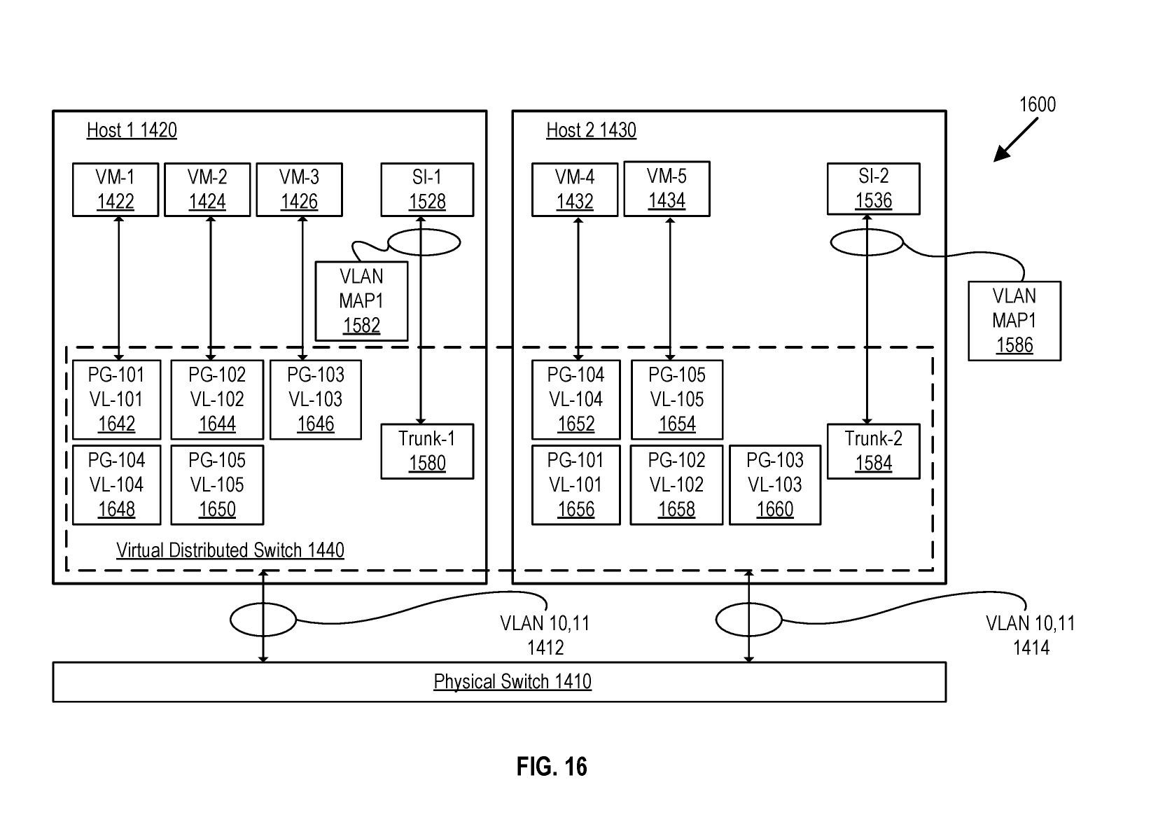

FIG. 16 is a block diagram illustrating an example system 1600 including microservices to intercept and perform security actions on network traffic sent between VMs in accordance with the disclosed embodiments. FIG. 15 includes host 1 1420 and host 2 1430, each of which is connected to physical switch 1410. FIG. 15 includes virtual distributed switch 1440 spanning across host 1 1420 and host 2 1430, which provides the switching among the VMs and the tunneling that is required to send data from VMs to physical switch 1410. Each host includes one or more VMs running on the corresponding host. For example, host 1 1420 includes VM-1 1422, VM-2 1424, and VM03 1426, and host 2 1430 includes VM-4 1432 and VM-5 1434. Each VM is assigned to a separate and unique port group (PG). In the example depicted in FIG. 16, VM-1 1422 is assigned to PG-101 1642, VM-2 1424 is assigned to PG-102 1644, VM-3 1426 is assigned to PG-103 1646, VM-4 1432 is assigned to PG-104 1652, and VM-5 1434 is assigned to PG-105 1654. In addition, each port group is associated with a different VLAN (e.g., PG-101 1642 is assigned VL-101, PG-102 1644 is assigned VL-102, PG-103 1646 is assigned VL-103, PG-104 1652 is assigned VL-104, and PG-105 1654 is assigned VL-105. In one embodiment, for each new VM created, a port group and VLAN is created for assignment to the new VM.

In one embodiment, each host includes the port groups for VMs that are in other hosts. For example, host 1 1420 maintains port groups PG-104 1648 and PG-105 1650, and host 2 1430 maintains port groups PG-101 1656, PG-102 1658, and PG-103 1660, even though no VMs within the corresponding host are assigned to the port groups. In one embodiment, when a new VM is added to a first host, a configuration microservice establishes a new port group on the first host, where the new port group is associated with a new VLAN, and assigns the new VM to the new port group. Further, in response to the new VM and new port group being added to the first host, the configuration microservice establishes an identical port group on any other host sharing the same vSwitch. Using the example of FIG. 16, when a new VM and new port group associated with the new VM are added to host 1 1420, the configuration microservice adds the same new port group to host 2 1430 because both hosts utilize virtual distributed switch 1440. In such a situation, the new port group is added to host 2 1430 even if a VM is not associated with the new port group in host 2 1430.

Maintaining port groups associated with VMs on different hosts facilitates migration processes of the VMs. In one embodiment, prior to migrating a VM from a first host to a second host, a migration manager determines whether a port group assigned to the VM on the first host exists on the second host. When the port group does not exist, the migration manager establishes the port group on the second host prior to performing the migration of the VM.

Host 1 1420 further includes SI-1 1528 connected to Trunk-1 1580, and host 2 1430 includes SI-2 1536 connected to Trunk-2 1584. The SIs implement VLAN Map 1582/1586, which maintains a mapping between the VLAN assigned to a port group and the VLAN used by virtual distributed switch 1440 for communications with physical switch 1410. In one embodiment, as described in more detail in FIG. 11, interface microservice (e.g., SI-1 1528) determines whether the network traffic matches a packet filter. In response to SI-1 1528 determining the network packet matches a packet filter, SI-1 1528 executes a security action. In one embodiment, executing a security action includes SI-1 1528 performing security actions on the traffic or passing the data to one or more other microservices (e.g., microservices 108-122 in FIG. 1) to perform security action.

In one embodiment, system 1600 allows for segment interfaces to intercept all traffic sent by a VM for the performance of security actions on the traffic. For example, VM-1 1422 in Host 1 1420 sends packets to virtual distributed switch 1440 for transmission to a VM in another host (e.g., VM-4 1432 in Host 2 1430). PG-101 1642 receives the packets and assigns them to VL-101. Prior to virtual distributed switch 1440 transmitting the packets, Trunk-1 1580 intercepts the packets and send the packets to SI-1 1528. SI-1 1528 uses VLAN MAP1 1582 to map VL-101 to a VLAN for transmitting to physical switch 1410 (e.g., VLAN 10 1412). SI-1 returns the packets back to virtual distributed switch 1440 via Trunk-1 1580, and virtual distributed switch 1440 transmits the packets to physical switch 1410 over a VLAN (e.g., VLAN 10, 11 1412) for sending to host 2 1430.

Similarly, VM-1 1422 in Host 1 1420 sends packets to virtual distributed switch 1440 for transmission to a VM in the same host (e.g., VM-2 1424). PG-101 1642 receives the packets and assigns them to VL-101. Prior to virtual distributed switch 1440 transmitting the packets to VM-2 1424, Trunk-1 1580 intercepts the packets and send the packets to SI-1 1528. SI-1 1528 uses VLAN MAP1 1582 to map VL-101 to VL-102. SI-1 returns the packets back to virtual distributed switch 1440 via Trunk-1 1580, and virtual distributed switch 1440 transmits the packets to VM-2 1424.

By assigning each VM to a unique port group, embodiments provide a benefit by allowing a security service (e.g., security service 124) to intercept and analyze any of the network traffic being communicated between VMs (e.g., between VM-1 1422, VM-2 1424, VM-3 1426, VM-4 1432, and VM-5 1434). Thus, this allows security service 124 to observe VM to VM traffic that may be indicative of a lateral infiltration (a security compromise spreading from peer to peer). This also allows security service 124 to observe VM to VM traffic that could be used to establish baseline behaviors and traffic patterns to establish risk levels.

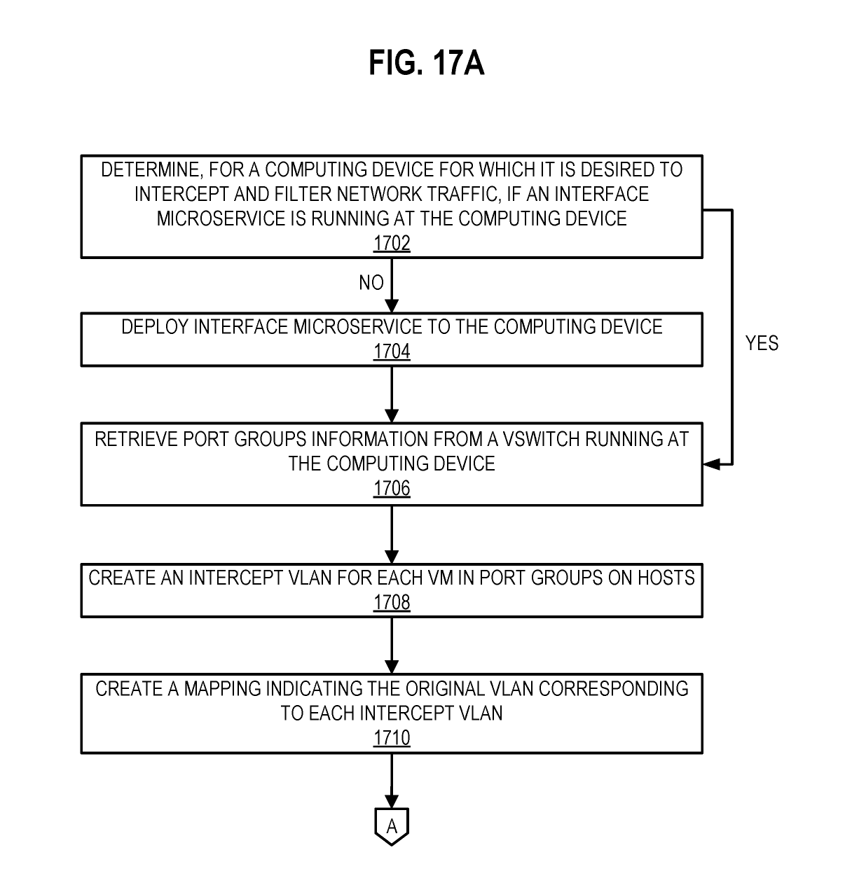

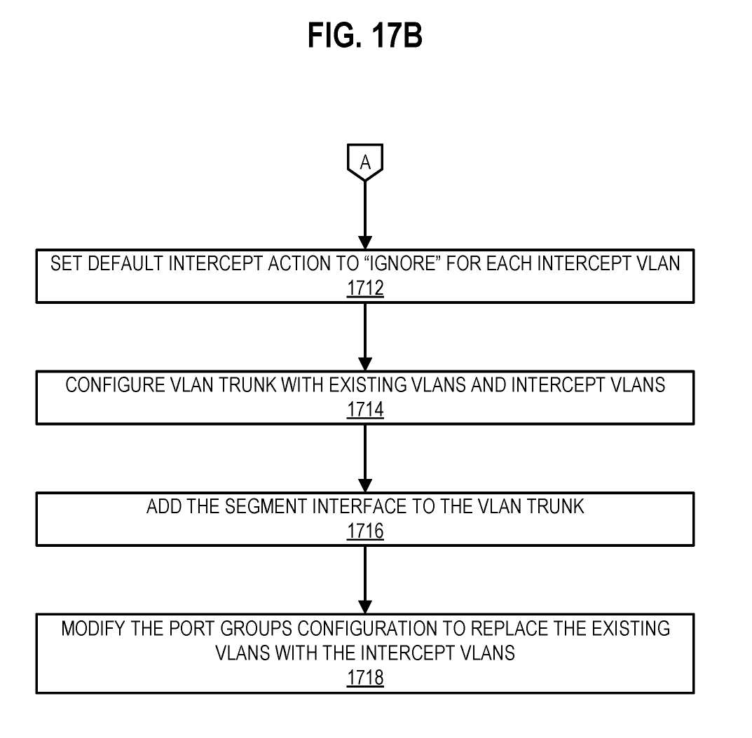

FIGS. 17A, 17B illustrate embodiments of a method of configuring a vSwitch to enable an interface microservice to intercept and filter network traffic routed by the vSwitch. At a high level, the method in FIGS. 17A, 17B describes inserting an interface microservice into a packet flow managed by a vSwitch (e.g., virtual distributed switch 1440 in FIG. 16) in a way that is transparent to devices outside of the local area network(s) managed by the vSwitch. As described in more detail hereinafter, by enabling an interface microservice to transparently intercept network traffic at a vSwitch, the interface microservice can efficiently filter network traffic and determine whether to perform additional security operations on network traffic at the packet level. Although FIGS. 17A, 17B describes operations performed by a configuration microservice (e.g., a configuration microservice 202), some or all of the operations described in FIGS. 17A, 17B can be performed by a configuration microservice, an interface microservice (e.g., segment interface 1528), another type of microservice, an application, or any other computer-executable logic. The method 1700 is described with respect to FIG. 16.

At block 1702, a configuration microservice determines, for a computing device (e.g., host device 1 1420 in FIG. 16) for which it is desired to intercept and filter network traffic, if an interface microservice (e.g., segment interface 1528) is running at host device 1 1420. If segment interface 1528 is not currently running on host device 1 1420, the method proceeds to block 1704. Otherwise, if segment interface 1528 is currently running on host device 1 1420, the method proceeds to block 1706.

At block 1704, if segment interface 1528 is not currently running on host device 1 1420, the configuration microservice deploys (e.g., installs) segment interface 1528 on host device 1 1420.

In an embodiment, host device 1 1420, for which it is desired to intercept and filter network traffic includes at least one hypervisor, and at least one VM is running on the at least one hypervisor. As illustrated in the embodiment in FIG. 16, for example, host device 1 1420 includes at least one hypervisor (not shown), where at least one VM (e.g., VMs 1422-1426) is running on the hypervisor. In one embodiment, the at least one VM includes a VNIC that is connected to a port of virtual distributed switch 1440, which routes network traffic for a plurality of VNICs connected to virtual distributed switch 1440.

In an embodiment, virtual distributed switch 1440 is associated with configuration information which includes, for example, a port groups configuration 802. The port groups configuration 802 includes information defining one or more port groups managed by virtual distributed switch 1440, where each port group is associated with a set of member VNICs. For example, one port group of port groups configuration 802 might include VNIC 708 and some number of other VNICs of the VM 704 or other VMs. In one embodiment, where each VM has a unique port group, the port groups configuration 802 includes an entry in port group 820 for each unique port group, where port group VLAN 824 includes the unique VLAN associated with each port group/VM.

At block 1706, segment interface 1528 retrieves port groups information from the configuration for virtual distributed switch 1440 running on host device 1 1420. As indicated above, the port groups configuration 802 indicates, for each port group, which VNICs (and associated VM) are members of the port group and further identifies a mapping with an associated VLAN. In one embodiment, the set of VLANs associated with the port groups defined in a port groups configuration 802 of virtual distributed switch 1440 is referred to herein as a set of existing, or original, VLANs.

In one embodiment, the configuration microservice determines whether a port group is associated with more than one VM. For example, the configuration microservice determines that multiple VMs are associated with the same port group identifier. In response to this determination, the configuration microservice segments the port group into a plurality of port groups. For example, the configuration microservice creates or establishes a plurality of new port groups (and corresponding port group identifiers), and assigns a different port group identifier to each one of the multiple VMs.

At block 1708, the configuration microservice creates, for each VM in port groups on one or more hosts (e.g., host 1 1420 and host 2 1430), a corresponding intercept VLAN. For example, for each VM associated with an original VLAN associated with a port group from port groups configuration 802 of virtual distributed switch 1440, a configuration microservice can create a corresponding intercept VLAN. Thus, each VM is assigned a unique intercept VLAN. In general, each of the intercept VLANs created at block 1708 represents an internal version of a corresponding original VLAN and can be used to route the original VLAN traffic to a segment interface 1528, as further described in the following operations.

At block 1710, the configuration microservice creates a mapping indicating the original VLAN corresponding to each intercept VLAN created at block 1708. In one embodiment, the mapping is stored by segment interface 1528 (e.g., illustrated in FIG. 16 as VLAN MAP1 1582) such that segment interface 1528 can translate network packets associated with an original VLAN into packets associated with an intercept VLAN, and vice versa. The process of FIG. 17A then proceeds to block 1712 in FIG. 17B via off-page connector A).

At block 1712, the configuration microservice optionally sets a default intercept action to “ignore” for each created intercept VLAN. For example, a configuration microservice might configure segment interface 1528 initially to ignore network packets routed by virtual distributed switch 1440 until further security processing is desired. In effect, setting segment interface's 1528 intercept action to “ignore” causes segment interface 1528 to operate in a “pass-through”mode, whereby packets received by the microservice are passed through segment interface 1528 without processing. In this example, segment interface 1528 receives network packets associated with an intercept VLAN, translates the intercept VLAN to an original VLAN, and causes the network packets to be sent out a network path 724. In this manner, other networked devices receiving the network packets via network path 724 can be unaware of the intercept VLAN originally associated with the network packets.

At block 1714, the configuration microservice configures a VLAN trunk (e.g., Trunk-1 1580) to include the original VLANs and the intercept VLANs. At a high level, a VLAN trunk is a network link used to carry traffic for multiple VLANs and to operate as a single logical link for multiple virtual links. In an embodiment, the VLAN trunk configured at block 1714 is able to carry traffic for both the original VLANs and the intercept VLANs created at block 1708. As described above, network traffic can be associated with a particular VLAN based on a VLAN tag included with the network packets (e.g., by a VM originating a network packet, an interface microservice intercepting a network packet, or another device).

At block 1716, the configuration microservice adds segment interface 1528 to the VLAN trunk. In an embodiment, adding segment interface 1528 to the VLAN trunk enables segment interface 1528 to receive network traffic associated with either the original or intercept VLANs (e.g., network traffic associated with an intercept VLAN by a VM or network traffic arriving at network path (e.g., VLAN 10/12 1412) associated with an original VLAN).

At block 1718, the configuration microservice modifies the port groups configuration at host device 1 1420 to use the intercept VLAN. For example, a configuration microservice modifies the port group assigned to a VM to use the intercept VLAN mapped to the original VLAN. Using the example of FIG. 16, the configuration microservice modifies PG-101 1642 to use intercept VLAN VL-101, which is mapped to the original VLAN (e.g., VLAN 10 1412). Based on the modification to the port group configuration, the VM includes a VLAN tag of the intercept VLAN with network packets sent from the VM. As described in more detail in reference to FIG. 11, because the network packets are associated with the intercept VLAN, the virtual distributed switch 1440 routes the traffic to SI-1 1528 via the VLAN Trunk-1 1580.

### 4.0. EXAMPLE EMBODIMENTS

Examples of some embodiments are represented, without limitation, by the following:

In some embodiments, a computer-implemented method comprises: retrieving, from a virtual switch running on a plurality of hosts in a computing environment, configuration information including a mapping between at least one port group identifier and at least a first virtual local area network (VLAN) identifier, each port group identifier associated with a separate virtual machine. The method further comprises, for each virtual machine, creating a separate intercept VLAN corresponding to the first VLAN identifier. The method further comprises adding the first VLAN identifier, an intercept VLAN identifier corresponding to an intercept VLAN, and an interface microservice to a VLAN trunk. The method further comprises modifying the configuration information to replace the first VLAN identifier with the intercept VLAN identifier. The method further comprises receiving, from the virtual switch and as part of the VLAN trunk, a network packet from a virtual machine associated with the intercept VLAN. The method further comprises determining whether the network packet matches a packet filter, and executing a security action in response to determining the network packet matches a packet filter.

In some embodiments, one or more of the following applies: 1) the method further comprises determining the at least one port group identifier is associated with a plurality of virtual machines; generating a plurality of port group identifiers; and assigning a separate port group identifier from the generated plurality of port group identifiers to each of the plurality of virtual machines; 2) the method further comprises receiving a request to add a new virtual machine to a first host in the plurality of hosts; in response to adding the new virtual machine to the first host, establishing a new port group on the first host; and assigning the new virtual machine to the new port group; 3) the method further comprises, in response to establishing the new port group on the first host, establishing the new port group on one or more other hosts in the plurality of hosts in the computing environment; 4) the method further comprises, in response to determining that the network packet matches the packet filter, sending the network packet to a security microservice which performs one or more security operations on the network packet; 5) the method further comprises, in response to determining that the network packet does not match the packet filter, modifying the network packet based on the first VLAN identifier and forwarding the network packet to the first VLAN; and 6) the method further comprises modifying the virtual machine to use the intercept VLAN for network traffic associated with the virtual machine.

In some embodiments, one or more non-transitory computer-readable storage media store instructions which, when executed by one or more hardware processors, cause performance of a method comprising: retrieving, from a virtual switch running on a plurality of hosts in a computing environment, configuration information including a mapping between at least one port group identifier and at least a first virtual local area network (VLAN) identifier, each port group identifier associated with a separate virtual machine. The method further comprises, for each virtual machine, creating a separate intercept VLAN corresponding to the first VLAN identifier. The method further comprises adding the first VLAN identifier, an intercept VLAN identifier corresponding to an intercept VLAN, and an interface microservice to a VLAN trunk. The method further comprises modifying the configuration information to replace the first VLAN identifier with the intercept VLAN identifier. The method further comprises receiving, from the virtual switch and as part of the VLAN trunk, a network packet from a virtual machine associated with the intercept VLAN. The method further comprises determining whether the network packet matches a packet filter, and executing a security action in response to determining the network packet matches a packet filter.

In some embodiments, one or more of the following applies: 1) the method further comprises determining the at least one port group identifier is associated with a plurality of virtual machines; generating a plurality of port group identifiers; and assigning a separate port group identifier from the generated plurality of port group identifiers to each of the plurality of virtual machines; 2) the method further comprises receiving a request to add a new virtual machine to a first host in the plurality of hosts; in response to adding the new virtual machine to the first host, establishing a new port group on the first host; and assigning the new virtual machine to the new port group; 3) the method further comprises, in response to establishing the new port group on the first host, establishing the new port group on one or more other hosts in the plurality of hosts in the computing environment; 4) the method further comprises, in response to determining that the network packet matches the packet filter, sending the network packet to a security microservice which performs one or more security operations on the network packet; 5) the method further comprises, in response to determining that the network packet does not match the packet filter, modifying the network packet based on the first VLAN identifier and forwarding the network packet to the first VLAN; and 6) the method further comprises modifying the virtual machine to use the intercept VLAN for network traffic associated with the virtual machine.

In some embodiments, an apparatus comprises: one or more hardware processors; and memory coupled to the one or more hardware processors, the memory storing instructions which, when executed by the one or more hardware processors, cause the apparatus to: retrieve, from a virtual switch running on a plurality of hosts in a computing environment, configuration information including a mapping between at least one port group identifier and at least a first virtual local area network (VLAN) identifier, each port group identifier associated with a separate virtual machine; for each virtual machine, create a separate intercept VLAN corresponding to the first VLAN identifier; add the first VLAN identifier, an intercept VLAN identifier corresponding to an intercept VLAN, and an interface microservice to a VLAN trunk; modify the configuration information to replace the first VLAN identifier with the intercept VLAN identifier; receive, from the virtual switch and as part of the VLAN trunk, a network packet from a virtual machine associated with the intercept VLAN; determine whether the network packet matches a packet filter; and execute a security action in response to determining the network packet matches a packet filter.

In some embodiments, one or more of the following applies: 1) the instructions further cause the apparatus to: determine the at least one port group identifier is associated with a plurality of virtual machines; generate a plurality of port group identifiers; and assign a separate port group identifier from the generated plurality of port group identifiers to each of the plurality of virtual machines; 2) the instructions further cause the apparatus to: receive a request to add a new virtual machine to a first host in the plurality of hosts; in response to adding the new virtual machine to the first host, establish a new port group on the first host; and assign the new virtual machine to the new port group; 3) the instructions further cause the apparatus to: in response to establishing the new port group on the first host, establish the new port group on one or more other hosts in the plurality of hosts in the computing environment; 4) the instructions further cause the apparatus to: in response to determining that the network packet matches the packet filter, send the network packet to a security microservice which performs one or more security operations on the network packet; 5) the instructions further cause the apparatus to: in response to determining that the network packet does not match the packet filter, modify the network packet based on the first VLAN identifier and forward the network packet to the first VLAN; and 6) the instructions further cause the apparatus to: modify the virtual machine to use the intercept VLAN for network traffic associated with the virtual machine.

Other examples of these and other embodiments are found throughout this disclosure.

### 5.0. IMPLEMENTATION MECHANISM—HARDWARE OVERVIEW

According to one embodiment, the techniques described herein are implemented by one or more special-purpose computing devices. The special-purpose computing devices may be desktop computer systems, portable computer systems, handheld devices, networking devices or any other device that incorporates hard-wired and/or program logic to implement the techniques. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, or FPGAs with custom programming to accomplish the techniques.

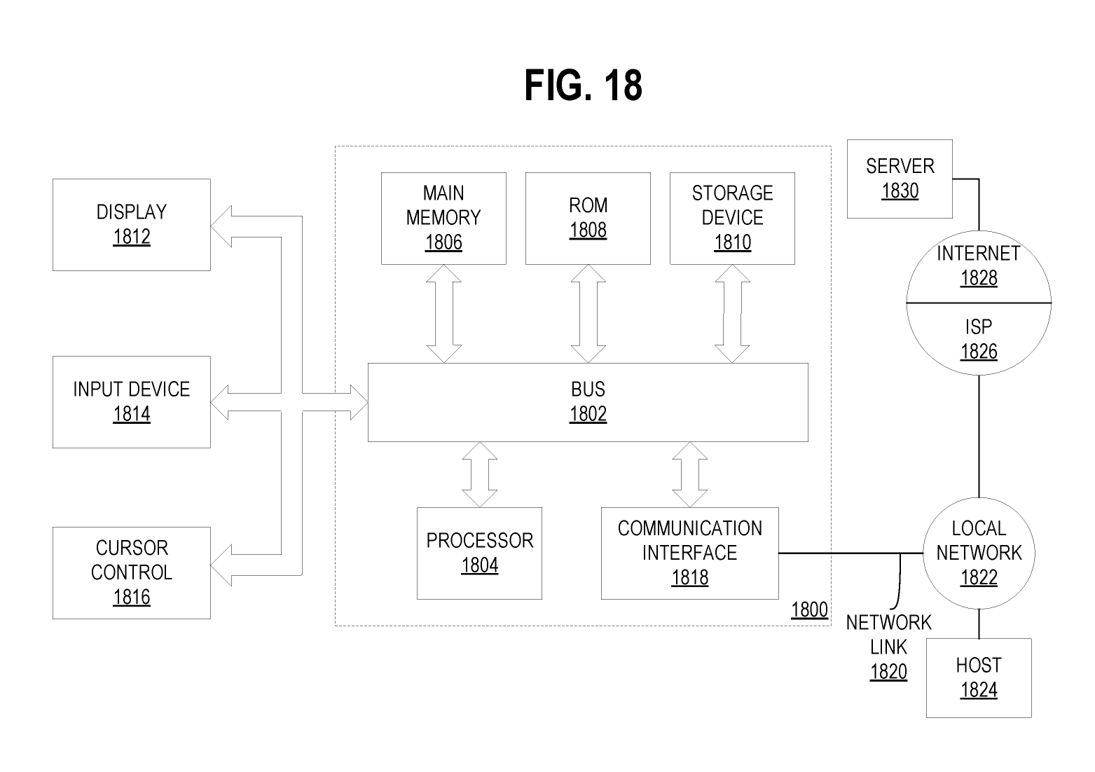

FIG. 18 is a block diagram that illustrates a computer system 1800 utilized in implementing the above-described techniques, according to an embodiment. Computer system 1800 may be, for example, a desktop computing device, laptop computing device, tablet, smartphone, server appliance, computing mainframe, multimedia device, handheld device, networking apparatus, or any other suitable device.

Computer system 1800 includes one or more buses 1802 or other communication mechanism for communicating information, and one or more hardware processors 1804 coupled with buses 1802 for processing information. Hardware processors 1804 may be, for example, general purpose microprocessors. Buses 1802 may include various internal and/or external components, including, without limitation, internal processor or memory busses, a Serial ATA bus, a PCI Express bus, a Universal Serial Bus, a HyperTransport bus, an Infiniband bus, and/or any other suitable wired or wireless communication channel.

Computer system 1800 also includes a main memory 1806, such as a random access memory (RAM) or other dynamic or volatile storage device, coupled to bus 1802 for storing information and instructions to be executed by processor 1804. Main memory 1806 also may be used for storing temporary variables or other intermediate information during execution of instructions to be executed by processor 1804. Such instructions, when stored in non-transitory storage media accessible to processor 1804, render computer system 1800 a special-purpose machine that is customized to perform the operations specified in the instructions.

Computer system 1800 further includes one or more read only memories (ROM) 1808 or other static storage devices coupled to bus 1802 for storing static information and instructions for processor 1804. One or more storage devices 1810, such as a solid-state drive (SSD), magnetic disk, optical disk, or other suitable non-volatile storage device, is provided and coupled to bus 1802 for storing information and instructions.

Computer system 1800 may be coupled via bus 1802 to one or more displays 1812 for presenting information to a computer user. For instance, computer system 1800 may be connected via an High-Definition Multimedia Interface (HDMI) cable or other suitable cabling to a Liquid Crystal Display (LCD) monitor, and/or via a wireless connection such as peer-to-peer Wi-Fi Direct connection to a Light-Emitting Diode (LED) television. Other examples of suitable types of displays 1812 may include, without limitation, plasma display devices, projectors, cathode ray tube (CRT) monitors, electronic paper, virtual reality headsets, braille terminal, and/or any other suitable device for outputting information to a computer user. In an embodiment, any suitable type of output device, such as, for instance, an audio speaker or printer, may be utilized instead of a display 1812.

One or more input devices 1814 are coupled to bus 1802 for communicating information and command selections to processor 1804. One example of an input device 1814 is a keyboard, including alphanumeric and other keys. Another type of user input device 1814 is cursor control 1816, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane. Yet other examples of suitable input devices 1814 include a touch-screen panel affixed to a display 1812, cameras, microphones, accelerometers, motion detectors, and/or other sensors. In an embodiment, a network-based input device 1814 may be utilized. In such an embodiment, user input and/or other information or commands may be relayed via routers and/or switches on a Local Area Network (LAN) or other suitable shared network, or via a peer-to-peer network, from the input device 1814 to a network link 1820 on the computer system 1800.

A computer system 1800 may implement techniques described herein using customized hard-wired logic, one or more ASICs or FPGAs, firmware and/or program logic which in combination with the computer system causes or programs computer system 1800 to be a special-purpose machine. According to one embodiment, the techniques herein are performed by computer system 1800 in response to processor 1804 executing one or more sequences of one or more instructions contained in main memory 1806. Such instructions may be read into main memory 1806 from another storage medium, such as storage device 1810. Execution of the sequences of instructions contained in main memory 1806 causes processor 1804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1810. Volatile media includes dynamic memory, such as main memory 1806. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, an EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 1802. Transmission media can also take the form of acoustic or light waves, such as those generated during radio-wave and infra-red data communications.

Various forms of media may be involved in carrying one or more sequences of one or more instructions to processor 1804 for execution. For example, the instructions may initially be carried on a magnetic disk or a solid state drive of a remote computer. The remote computer can load the instructions into its dynamic memory and use a modem to send the instructions over a network, such as a cable network or cellular network, as modulate signals. A modem local to computer system 1800 can receive the data on the network and demodulate the signal to decode the transmitted instructions. Appropriate circuitry can then place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

A computer system 1800 may also include, in an embodiment, one or more communication interfaces 1818 coupled to bus 1802. A communication interface 1818 provides a data communication coupling, typically two-way, to a network link 1820 that is connected to a local network 1822. For example, a communication interface 1818 may be an integrated services digital network (ISDN) card, cable modem, satellite modem, or a modem to provide a data communication connection to a corresponding type of telephone line. As another example, the one or more communication interfaces 1818 may include a local area network (LAN) card to provide a data communication connection to a compatible LAN. As yet another example, the one or more communication interfaces 1818 may include a wireless network interface controller, such as a 802.11-based controller, Bluetooth controller, Long Term Evolution (LTE) modem, and/or other types of wireless interfaces. In any such implementation, communication interface 1818 sends and receives electrical, electromagnetic, or optical signals that carry digital data streams representing various types of information.

Network link 1820 typically provides data communication through one or more networks to other data devices. For example, network link 1820 may provide a connection through local network 1822 to a host computer 1824 or to data equipment operated by a Service Provider 1826. Service Provider 1826, which may for example be an Internet Service Provider (ISP), in turn provides data communication services through a wide area network, such as the world wide packet data communication network now commonly referred to as the “Internet” 1828. Local network 1822 and Internet 1828 both use electrical, electromagnetic or optical signals that carry digital data streams. The signals through the various networks and the signals on network link 1820 and through communication interface 1818, which carry the digital data to and from computer system 1800, are example forms of transmission media.

In an embodiment, computer system 1800 can send messages and receive data, including program code and/or other types of instructions, through the network(s), network link 1820, and communication interface 1818. In the Internet example, a server X30 might transmit a requested code for an application program through Internet 1828, ISP 1826, local network 1822 and communication interface 1818. The received code may be executed by processor 1804 as it is received, and/or stored in storage device 1810, or other non-volatile storage for later execution. As another example, information received via a network link 1820 may be interpreted and/or processed by a software component of the computer system 1800, such as a web browser, application, or server, which in turn issues instructions based thereon to a processor 1804, possibly via an operating system and/or other intermediate layers of software components.

In an embodiment, some or all of the systems described herein may be or comprise server computer systems, including one or more computer systems 1800 that collectively implement various components of the system as a set of server-side processes. The server computer systems may include web server, application server, database server, and/or other conventional server components that certain above-described components utilize to provide the described functionality. The server computer systems may receive network-based communications comprising input data from any of a variety of sources, including without limitation user-operated client computing devices such as desktop computers, tablets, or smartphones, remote sensing devices, and/or other server computer systems.

In an embodiment, certain server components may be implemented in full or in part using “cloud”-based components that are coupled to the systems by one or more networks, such as the Internet. The cloud-based components may expose interfaces by which they provide processing, storage, software, and/or other resources to other components of the systems. In an embodiment, the cloud-based components may be implemented by third-party entities, on behalf of another entity for whom the components are deployed. In other embodiments, however, the described systems may be implemented entirely by computer systems owned and operated by a single entity.

In an embodiment, an apparatus comprises a processor and is configured to perform any of the foregoing methods. In an embodiment, a non-transitory computer readable storage medium, storing software instructions, which when executed by one or more processors cause performance of any of the foregoing methods.

### 6.0. EXTENSIONS AND ALTERNATIVES

As used herein, the terms “first,” “second,” “certain,” and “particular” are used as naming conventions to distinguish queries, plans, representations, steps, objects, devices, or other items from each other, so that these items may be referenced after they have been introduced. Unless otherwise specified herein, the use of these terms does not imply an ordering, timing, or any other characteristic of the referenced items.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. In this regard, although specific claim dependencies are set out in the claims of this application, it is to be noted that the features of the dependent claims of this application may be combined as appropriate with the features of other dependent claims and with the features of the independent claims of this application, and not merely according to the specific dependencies recited in the set of claims. Moreover, although separate embodiments are discussed herein, any combination of embodiments and/or partial embodiments discussed herein may be combined to form further embodiments.

Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A computer-implemented method, comprising:
retrieving, from a virtual switch running on a plurality of hosts in a computing environment, configuration information including a mapping between at least one port group identifier and at least a first virtual local area network (VLAN) identifier, each port group identifier associated with a separate virtual machine;
for each virtual machine, creating a separate intercept VLAN corresponding to the first VLAN identifier;
adding the first VLAN identifier, an intercept VLAN identifier corresponding to an intercept VLAN, and an interface microservice to a VLAN trunk;
modifying the configuration information to replace the first VLAN identifier with the intercept VLAN identifier;
receiving, from the virtual switch and as part of the VLAN trunk, a network packet from a virtual machine associated with the intercept VLAN;
determining whether the network packet matches a packet filter; and
executing a security action in response to determining the network packet matches a packet filter.

2. The method of claim 1, further comprising:
determining the at least one port group identifier is associated with a plurality of virtual machines;
generating a plurality of port group identifiers; and
assigning a separate port group identifier from the generated plurality of port group identifiers to each of the plurality of virtual machines.

3. The method of claim 1, further comprising:
receiving a request to add a new virtual machine to a first host in the plurality of hosts;
in response to adding the new virtual machine to the first host, establishing a new port group on the first host; and
assigning the new virtual machine to the new port group.

4. The method of claim 3, further comprising:
in response to establishing the new port group on the first host, establishing the new port group on one or more other hosts in the plurality of hosts in the computing environment.

5. The method of claim 1, further comprising:
in response to determining that the network packet matches the packet filter, sending the network packet to a security microservice which performs one or more security operations on the network packet.

6. The method of claim 1, further comprising:
in response to determining that the network packet does not match the packet filter, modifying the network packet based on the first VLAN identifier and forwarding the network packet to the first VLAN.

7. The method of claim 1, further comprising:
modifying the virtual machine to use the intercept VLAN for network traffic associated with the virtual machine.

8. One or more non-transitory computer-readable storage media storing instructions which, when executed by one or more hardware processors, cause performance of a method comprising:
retrieving, from a virtual switch running on a plurality of hosts in a computing environment, configuration information including a mapping between at least one port group identifier and at least a first virtual local area network (VLAN) identifier, each port group identifier associated with a separate virtual machine;
for each virtual machine, creating a separate intercept VLAN corresponding to the first VLAN identifier;
adding the first VLAN identifier, an intercept VLAN identifier corresponding to an intercept VLAN, and an interface microservice to a VLAN trunk;
modifying the configuration information to replace the first VLAN identifier with the intercept VLAN identifier;
receiving, from the virtual switch and as part of the VLAN trunk, a network packet from a virtual machine associated with the intercept VLAN;
determining whether the network packet matches a packet filter; and
executing a security action in response to determining the network packet matches a packet filter.

9. The one or more non-transitory computer-readable storage media of claim 8, further comprising:
determining the at least one port group identifier is associated with a plurality of virtual machines;
generating a plurality of port group identifiers; and
assigning a separate port group identifier from the generated plurality of port group identifiers to each of the plurality of virtual machines.

10. The one or more non-transitory computer-readable storage media of claim 8, further comprising:
receiving a request to add a new virtual machine to a first host in the plurality of hosts;
in response to adding the new virtual machine to the first host, establishing a new port group on the first host; and
assigning the new virtual machine to the new port group.

11. The one or more non-transitory computer-readable storage media of claim 10, further comprising:
in response to establishing the new port group on the first host, establishing the new port group on one or more other hosts in the plurality of hosts in the computing environment.

12. The one or more non-transitory computer-readable storage media of claim 8, further comprising:
in response to determining that the network packet matches the packet filter, sending the network packet to a security microservice which performs one or more security operations on the network packet.

13. The one or more non-transitory computer-readable storage media of claim 8, further comprising:
in response to determining that the network packet does not match the packet filter, modifying the network packet based on the first VLAN identifier and forwarding the network packet to the first VLAN.

14. The one or more non-transitory computer-readable storage media of claim 8, further comprising:
modifying the virtual machine to use the intercept VLAN for network traffic associated with the virtual machine.

15. An apparatus comprising:
one or more hardware processors;
memory coupled to the one or more hardware processors, the memory storing instructions which, when executed by the one or more hardware processors, causes the apparatus to:
retrieve, from a virtual switch running on a plurality of hosts in a computing environment, configuration information including a mapping between at least one port group identifier and at least a first virtual local area network (VLAN) identifier, each port group identifier associated with a separate virtual machine;
for each virtual machine, create a separate intercept VLAN corresponding to the first VLAN identifier;
add the first VLAN identifier, an intercept VLAN identifier corresponding to an intercept VLAN, and an interface microservice to a VLAN trunk;
modify the configuration information to replace the first VLAN identifier with the intercept VLAN identifier;
receive, from the virtual switch and as part of the VLAN trunk, a network packet from a virtual machine associated with the intercept VLAN;
determine whether the network packet matches a packet filter; and
execute a security action in response to determining the network packet matches a packet filter.

16. The apparatus of claim 15, wherein the instructions further cause the apparatus to:
determine the at least one port group identifier is associated with a plurality of virtual machines;
generate a plurality of port group identifiers; and
assign a separate port group identifier from the generated plurality of port group identifiers to each of the plurality of virtual machines.

17. The apparatus of claim 15, wherein the instructions further cause the apparatus to:
receive a request to add a new virtual machine to a first host in the plurality of hosts;
in response to adding the new virtual machine to the first host, establish a new port group on the first host; and
assign the new virtual machine to the new port group.

18. The apparatus of claim 17, wherein the instructions further cause the apparatus to:
in response to establishing the new port group on the first host, establishing the new port group on one or more other hosts in the plurality of hosts in the computing environment.

19. The apparatus of claim 15, wherein the instructions further cause the apparatus to:
in response to determining that the network packet matches the packet filter, sending the network packet to a security microservice which performs one or more security operations on the network packet.

20. The apparatus of claim 15, wherein the instructions further cause the apparatus to:
in response to determining that the network packet does not match the packet filter, modifying the network packet based on the first VLAN identifier and forwarding the network packet to the first VLAN.
